(19) United States
(12) Patent Application Publication
(10) Pub. No.: US 2015/0235180 A1
(43) Pub. Date: Aug. 20, 2015

(54) SYSTEM AND METHOD FOR UNIFYING AN EMPLOYMENT NETWORK OF RECRUITERS

(71) Applicant: RECRUITER MLS, INC., Orlando, FL (US)

(72) Inventor: John SARAVANJA, Oviedo, FL (US)

(21) Appl. No.: 14/624,217

(22) Filed: Feb. 17, 2015

Related U.S. Application Data
(60) Provisional application No. 61/939,792, filed on Feb. 14, 2014.

(51) Int. Cl. G06Q 10/10; G06Q 50/00

(52) U.S. Cl. CPC G06Q 10/1053; G06Q 50/01

(57) ABSTRACT

A system and method for unifying an employment network is disclosed. The system and method includes an open listing of candidates that may be represented by several different recruiters that are registered to use the system. The recruiters can use a graphical user interface of the system to invite their respective candidates to participate in the open listing of available candidates. The candidates that elect to participate in the open listing will be visible to recruiters other than the recruiter that currently represents the candidate. The system generates candidate profiles where the identity of a particular candidate is anonymous to recruiters that are searching for available candidates until an agreement is reached between a job owner recruiter seeking a candidate, a candidate owner recruiter that represents a candidate, the candidate, and/or any combination thereof.

### I. CROSS REFERENCE TO RELATED APPLICATIONS

This application claims the benefit of U.S. Provisional Application No. 61/939,792, filed on Feb. 14, 2014.

### II. FIELD OF THE INVENTION

The present invention relates generally to the employment industry, and more specifically to a system and method for unifying an employment network of recruiters.

### III. BACKGROUND

Recruiting firms recruit and represent candidates for potential placement with employers with job openings. The recruiters identify available jobs and then identify matching candidates that they represent for those jobs. Alternatively, the recruiters may represent a company that has a job opening and the recruiters will then identify and locate candidates for the job. The recruiters typically are paid by the company when the candidate is hired by the company. A shortcoming of this approach is that recruiters are not always able to quickly locate and identify the best candidates that are available for a job opening. For example, recruiters may only have a relationship with a few other recruiters that may share candidates or available job openings with each other. Thus, the pool of possible job candidates is limited. In addition, the best job candidates are typically currently employed and must remain anonymous to protect their current job situation. Accordingly, there is a need in the art for a method and system that can quickly identify available job candidates and expands the pool of job candidates for a job opening while maintaining the confidentiality of such candidates if necessary.

It is, therefore, to the effective resolution of the aforementioned problems and shortcomings of the prior art that the present invention is directed.

However, in view of the prior art at the time the present invention was made, it was not obvious to those of ordinary skill in the pertinent art how the identified needs could be fulfilled.

### IV. SUMMARY

The following presents a simplified summary of one or more embodiments in order to provide a basic understanding of some aspects of such embodiments. This summary is not an extensive overview of the one or more embodiments, and is intended to neither identify key or critical elements of the embodiments nor delineate the scope of such embodiments. Its sole purpose is to present some concepts of the described embodiments in a simplified form as a prelude to the more detailed description that is presented later.

A system and method for unifying an employment network of recruiters is disclosed. The system and method rapidly fills jobs and places candidates. The system and method includes an open listing of candidates that may be represented by several different recruiters that are registered to use the system. The recruiters can use the system to invite their respective candidates to participate in the open listing of available candidates. The candidates that elect to participate in the open listing will be visible to recruiters other than just the recruiter that currently represents the candidate. The system may initially display anonymous candidate profiles that recruiters can search for available candidates using a graphical user interface of the system and method. Once an agreement is reached between a job owner recruiter seeking a candidate, a candidate owner recruiter that represents a candidate, the candidate, and/or any combination thereof, the full profile of the candidate is provided.

In one aspect, the system includes the graphical user interface that is configured for the job owner recruiter (“JOR”) to request candidates from the candidate owner recruiter (“COR”). The JOR submits a request for a candidate to the COR, and the COR reviews the request. After reviewing the request, the COR can elect to reject the request or provide a candidate's contact information to the JOR.

In another aspect, COR can submit a candidate profile to the JOR, which the JOR is the recruiter that has posted a job request. The JOR reviews the candidate profile that was submitted by the COR and can elect to submit a formal request to the candidate owner recruiter for the candidate's full profile in an effort to fulfill the job request.

In another aspect, the system provides a graphical user interface that is searchable by a JOR. The JOR can submit a request to the COR for the candidate profile when the JOR identifies a potential candidate for a job request.

In another aspect, the system provides a graphical user interface for a COR to view a JOR's job requests directly and to submit a candidate profile to the JOR to potentially fill a particular job request.

In another aspect, the system provides a graphical user interface for a COR's candidate to submit his/her own candidate profile directly to a JOR. The JOR can elect to contact the COR upon reviewing the candidate profile, to potentially fill a particular job request.

An advantage of the system and method is that unaffiliated job candidates can instantly gain representation and are also free to disengage and re-engage from recruiter to recruiter.

Another advantage is that the system and method allows recruiters to freely search a database of recruiter-represented (affiliated) candidates. In addition, a recruiter can securely showcase his inventory of represented candidates.

Yet another advantage of the system is that a recruiter has his inventory of candidates working for him 24/7/365—even while he or she sleeps. This is made possible by all of the other recruiters and their candidates accessing the system and looking to fulfill job requests.

These and other important objects, advantages, and features of the system and method will become clear as this description proceeds.

To the accomplishment of the foregoing and related ends, one or more embodiments comprise the features hereinafter fully described. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### V. BRIEF DESCRIPTION OF THE DRAWINGS

FIG. 1 is a diagrammatic representation of the job owner recruiter submitting a request for a candidate from a candidate owner recruiter;

FIG. 2 is a diagrammatic representation of the candidate owner recruiter reviewing the request;

FIG. 3 is a diagrammatic representation of the candidate owner recruiter not approving the request;

FIG. 4 is a diagrammatic representation of the candidate owner recruiter approving the request and determining whether a contract already exists;

FIG. 5 is a diagrammatic representation of the job owner recruiter reviewing the candidate profile;

FIG. 6 is a diagrammatic representation of the job owner recruiter signing contract from candidate owner recruiter in order to receive permission to contact the candidate;

FIG. 7 is a diagrammatic representation of the candidate being hired by the company and fulfilling the job request;

FIG. 8 is a diagrammatic representation of the job owner recruiter and candidate owner recruiter splitting the commission;

FIG. 9 is a screen shot of the graphical user interface of the job owner recruiter requesting a candidate from a candidate owner recruiter;

FIG. 10 is a screen shot of the graphical user interface of the candidate owner recruiter accepting a request for a candidate from a job owner recruiter;

FIG. 11 is a screen shot of the graphical user interface of the candidate owner recruiter rejecting a request for a candidate from a job owner recruiter;

FIG. 12 is a screen shot of the graphical user interface of the candidate owner recruiter accepting a request for a candidate from a job owner recruiter;

FIG. 13 is a diagrammatic representation of the candidate owner recruiter reviewing the job owner recruiter job requests;

FIG. 14 is a diagrammatic representation of candidate owner recruiter presenting a candidate profile to the job owner recruiter to fulfill the job request;

FIG. 15 is a diagrammatic representation of the job owner recruiter reviewing the candidate profile submitted by the candidate owner recruiter;

FIG. 16 is a diagrammatic representation of the job owner recruiter not approving the candidate profile submitted by the candidate owner recruiter;

FIG. 17 is a diagrammatic representation of the candidate owner recruiter approving the candidate profile submitted by the job owner recruiter;

FIG. 18 is a diagrammatic representation of the candidate owner recruiter not approving the candidate profile;

FIG. 19 is a diagrammatic representation of the job owner recruiter presenting candidate profile to the company for the job request;

FIG. 20 is a diagrammatic representation of the candidate being hired by the company and fulfilling the job request;

FIG. 21 is a diagrammatic representation of the job owner recruiter and candidate owner recruiter splitting the commission;

FIG. 22 is a screen shot of the graphical user interface of the candidate owner recruiter submitting candidates to the user as a job owner recruiter;

FIG. 23 is a screen shot of the graphical user interface of the user as a candidate owner recruiter submitting candidates to a job owner recruiter;

FIG. 24 is a screen shot of the graphical user interface of the candidate owner recruiter submitting a candidate profile to a job owner recruiter;

FIG. 25 is a screen shot of the graphical user interface of the candidate owner recruiter submitting candidates to the user as a job owner recruiter;

FIG. 26 is a screen shot of the graphical user interface of the job owner recruiter not accepting a candidate submitted by the candidate owner recruiter;

FIG. 27 is a diagrammatic representation of a candidate searching posted job requests by a job owner recruiter;

FIG. 28 is a diagrammatic representation of the job owner recruiter reviewing the candidate;

FIG. 29 is a diagrammatic representation of the job owner recruiter not approving the candidate;

FIG. 30 is a diagrammatic representation of the job owner recruiter approving the candidate submitting a request to the candidate owner recruiter regarding the candidate;

FIG. 31 is a diagrammatic representation of the candidate owner recruiter not approving the candidate request from the job owner recruiter;

FIG. 32 is a diagrammatic representation of the job owner recruiter approving the request and determining whether a contract already exists;

FIG. 33 is a diagrammatic representation of the candidate being hired by the company and fulfilling the job request;

FIG. 34 is a diagrammatic representation of the job owner recruiter and candidate owner recruiter splitting the commission;

FIG. 35 is a screen shot of the graphical user interface of candidate owner recruiter candidates searching the job owner recruiter job requests;

FIG. 36 is a screen shot of the graphical user interface of the candidate owner recruiter candidates submitting their profiles directly to the job owner recruiter;

FIG. 37 is a screen shot of the graphical user interface of the job requests;

FIG. 38 is a screen shot of the graphical user interface of a detailed description of the job requests;

FIG. 39 is a screen shot of the graphical user interface of the candidate owner recruiter candidates applying to the user as the job owner recruiter job requests;

FIG. 40 is a screen shot of the graphical user interface of the job requests viewable by candidates and other candidate owner recruiters; and

FIG. 41 is a screen shot of the graphical user interface of the candidates viewable by other recruiters.

### VI. DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

All the candidates in the system and method for unifying an employment network are represented by recruiters. A recruiter that has a job order to fill from a client is referred to as a “job owner recruiter” or “JOR.” A recruiter that is the source of a candidate and represents that candidate is referred to as a “candidate owner recruiter” or “COR.”

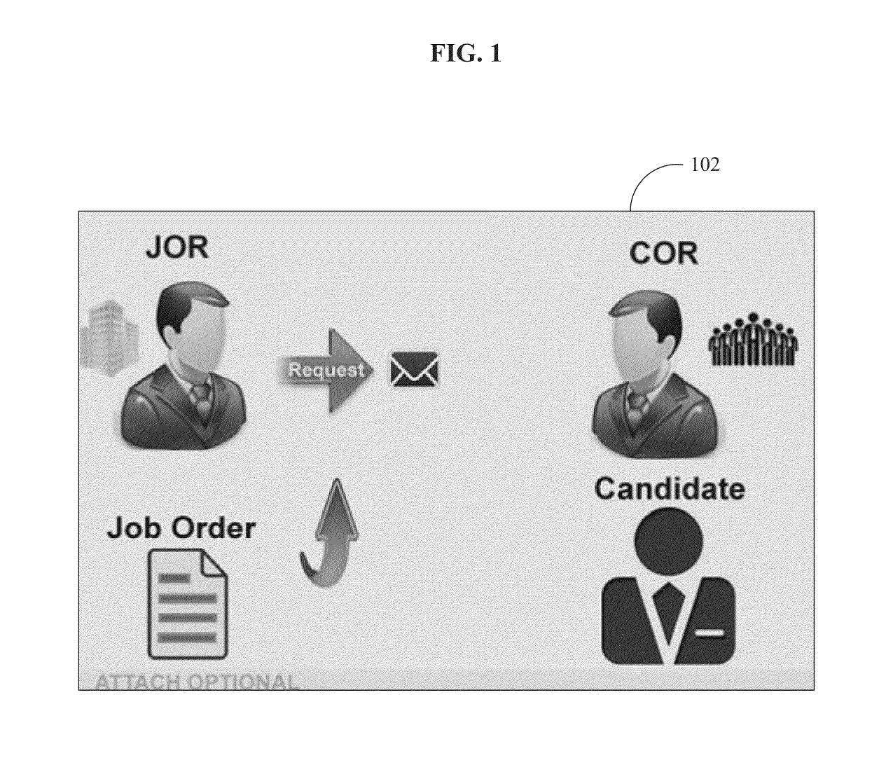

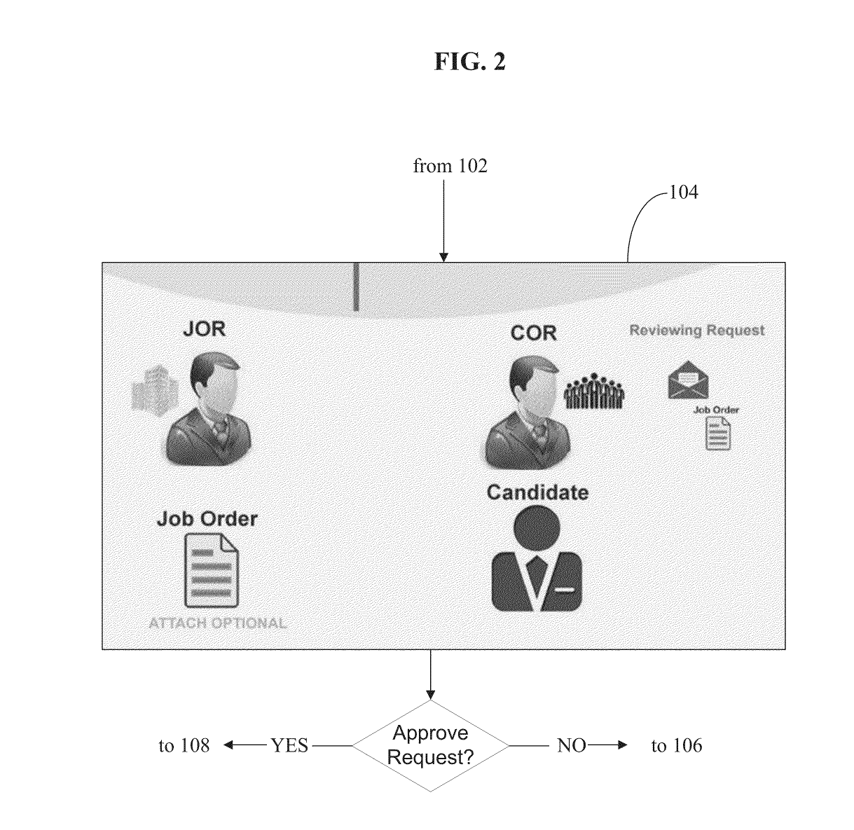

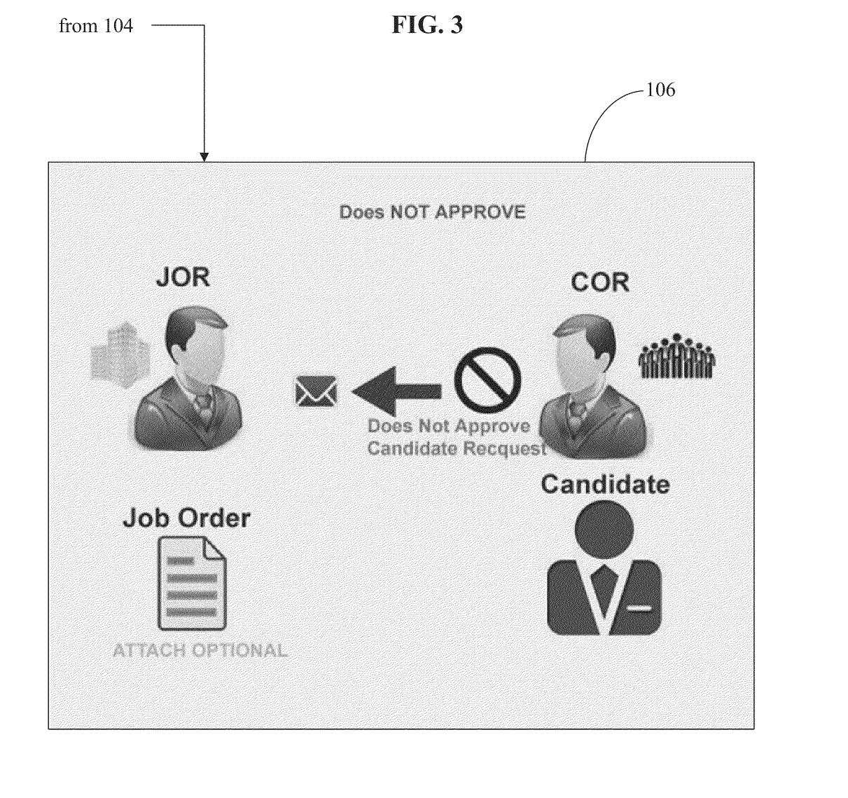

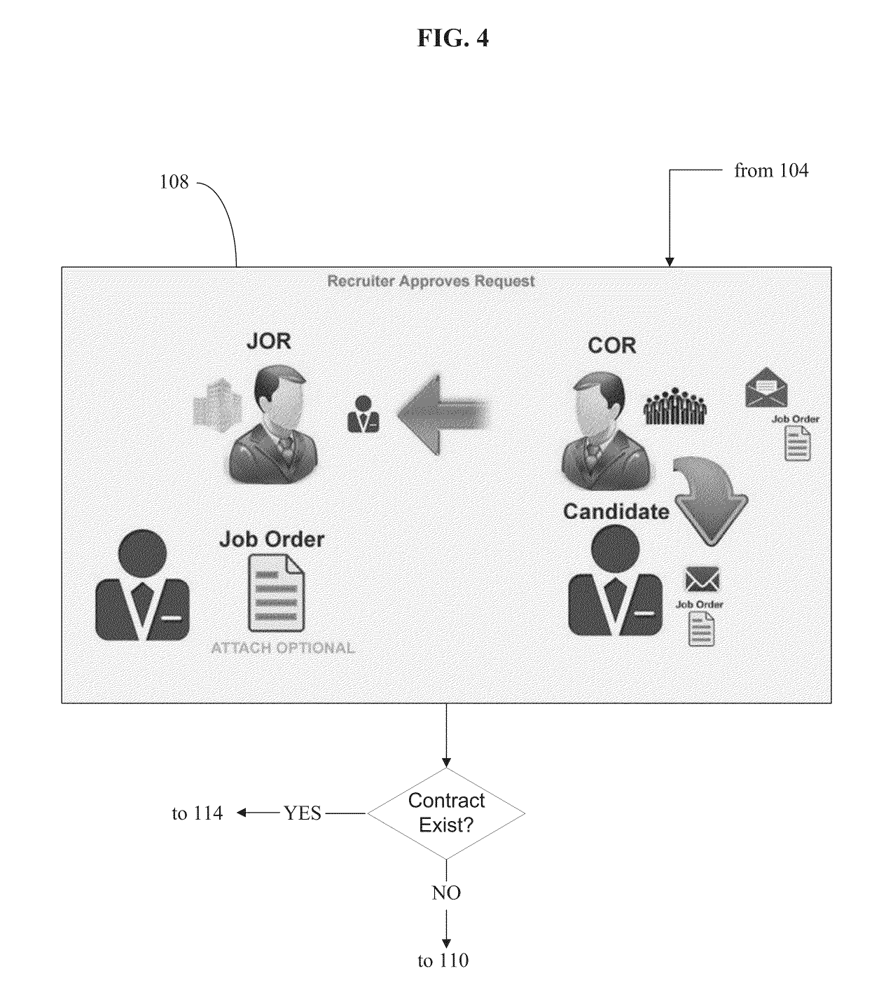

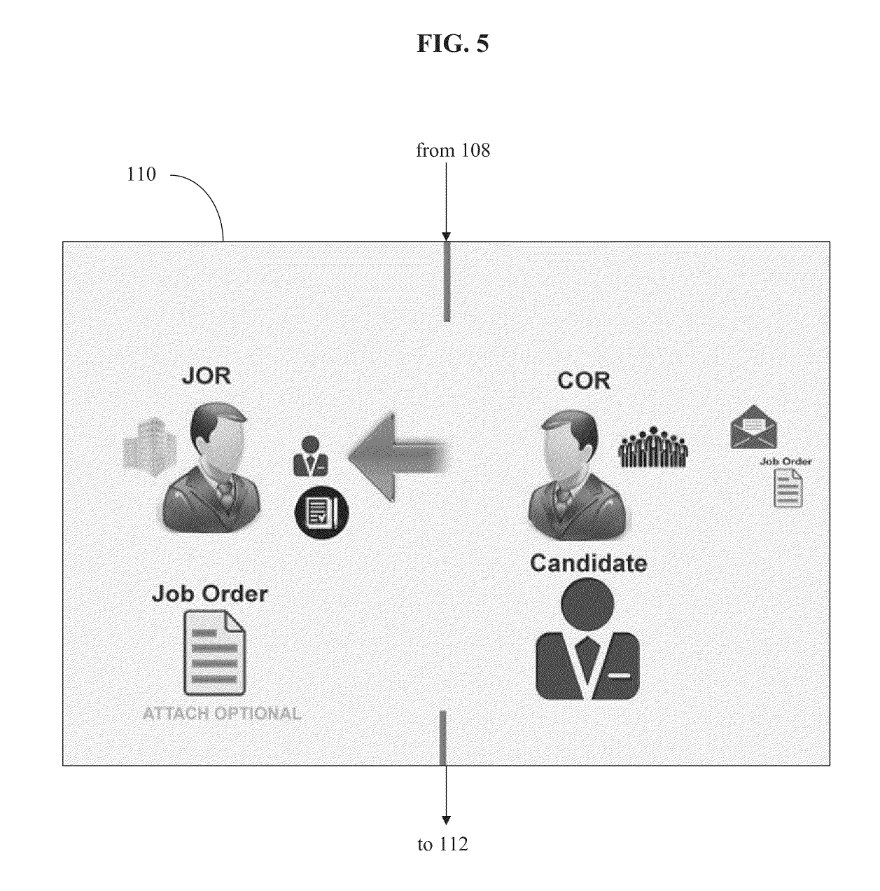

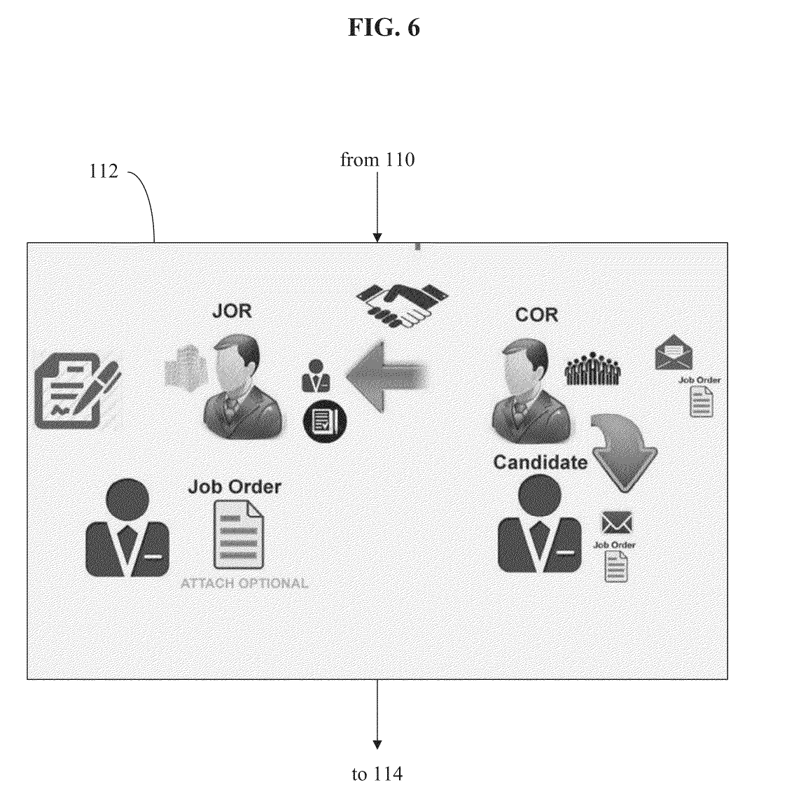

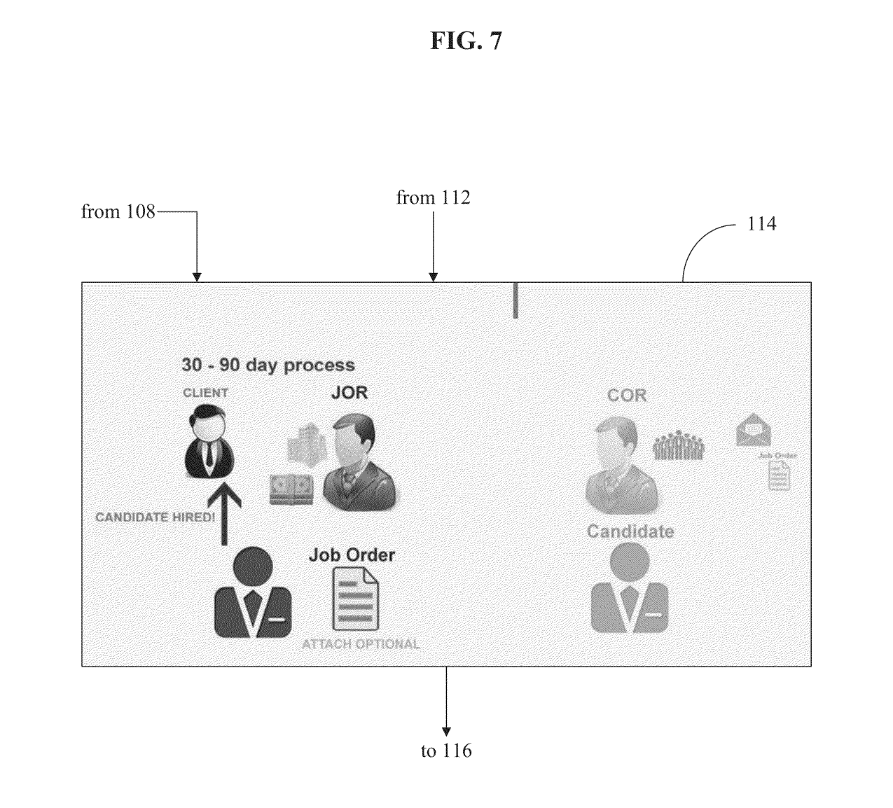

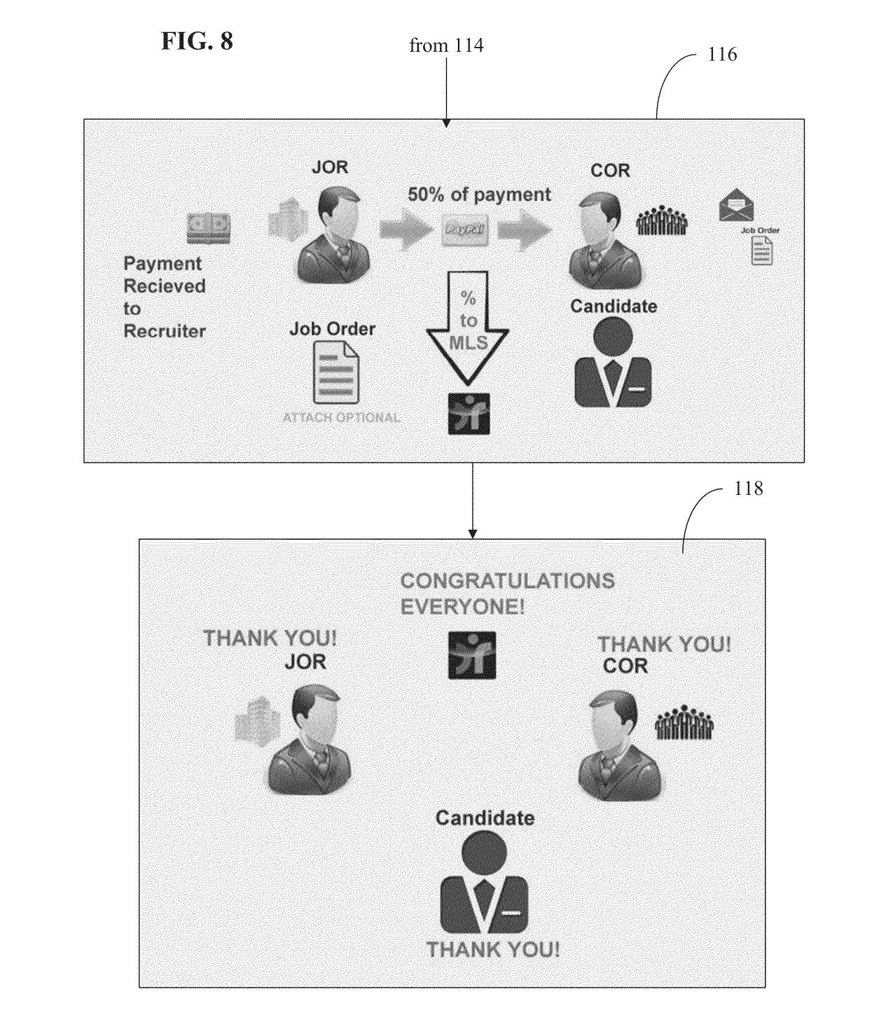

Referring to FIGS. 1-8, the JOR receives a job order from a client, at 102. The JOR needs to fill that job order but may not currently represent an appropriate candidate for the job order. Accordingly, the JOR submits a request for candidates to other recruiters that may have appropriate candidates for the job order. The request includes the qualification and requirements for potential candidates such as required educational or work experience, for example. The COR reviews the request, at 104, and determines whether the COR represents an appropriate candidate based on the request. If the COR does not represent an appropriate candidate or otherwise does not want to provide a candidate to the JOR, then the COR responds, at 106, the request is not approved.

If the COR does represent an appropriate candidate and the candidate agrees to be considered for the job order, then the COR responds, at 108, to the JOR with the selected candidate's profile. The JOR will determine if a contract may exist between the selected candidate(s) and the JOR. If no contract exists, then the JOR and the selected candidate will execute a contract, at 110, and the JOR will present the selected candidate to the client for review, at 112. The selected candidate will be reviewed with the client, at 114, and hired. Moving to 116, once the selected candidate is hired, the JOR and COR will share the commission earned for placement of the selected candidate.

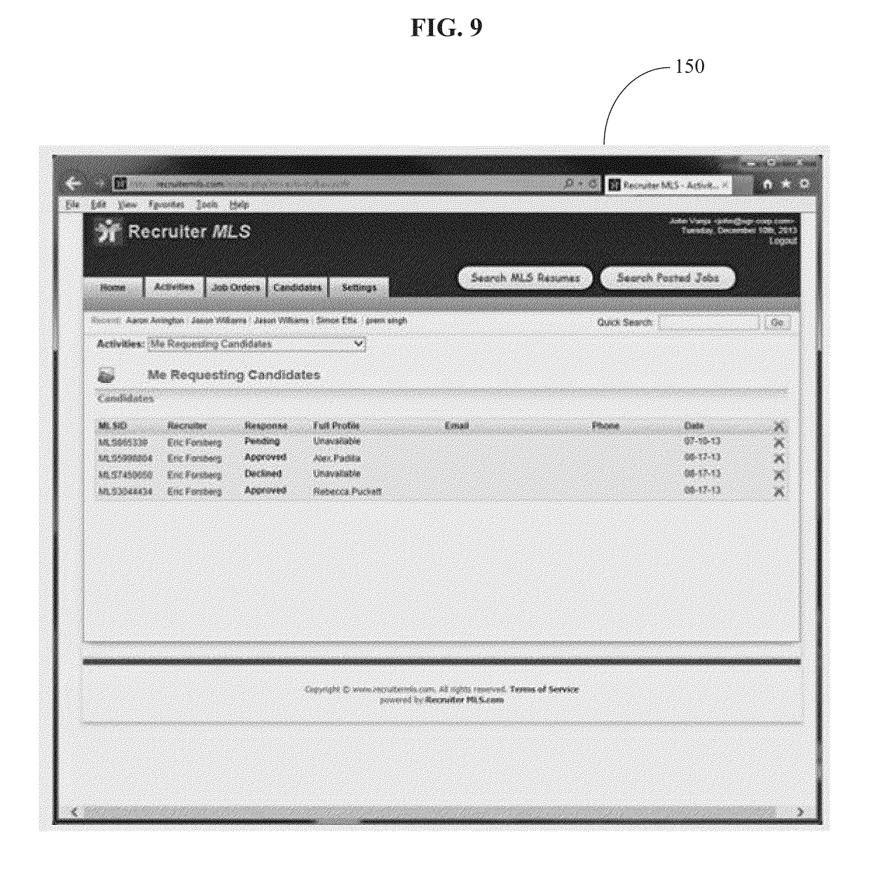

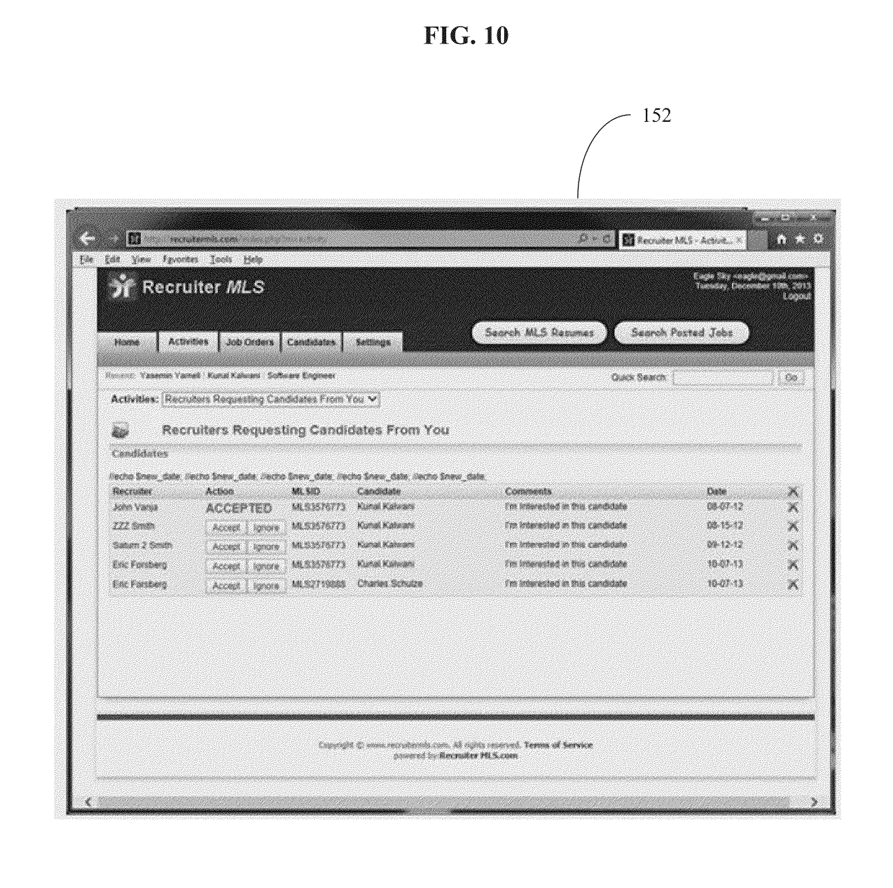

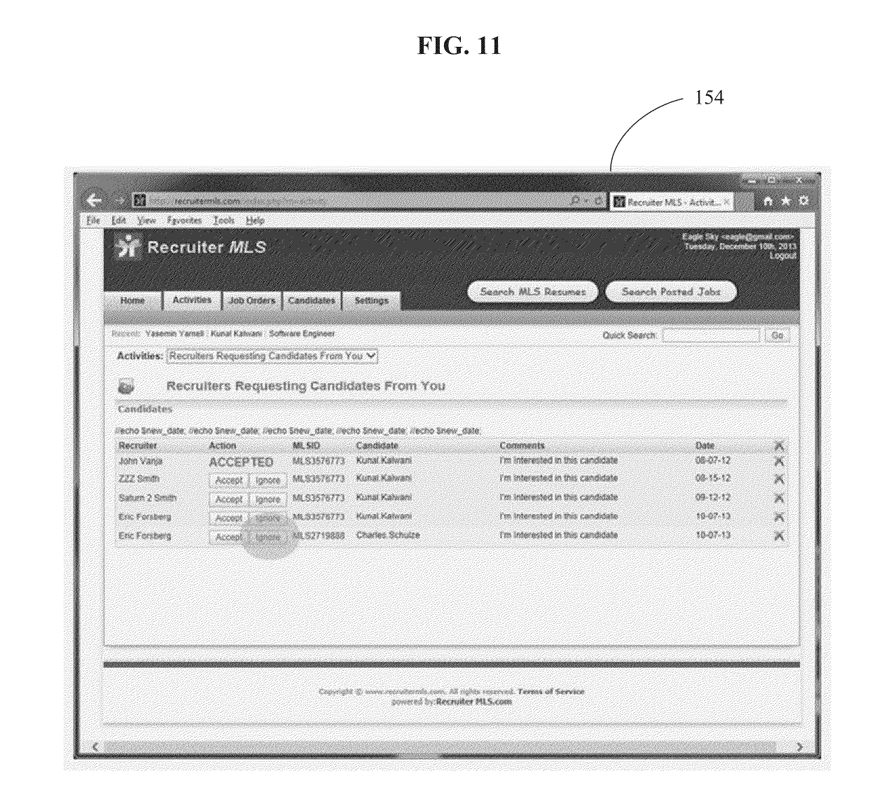

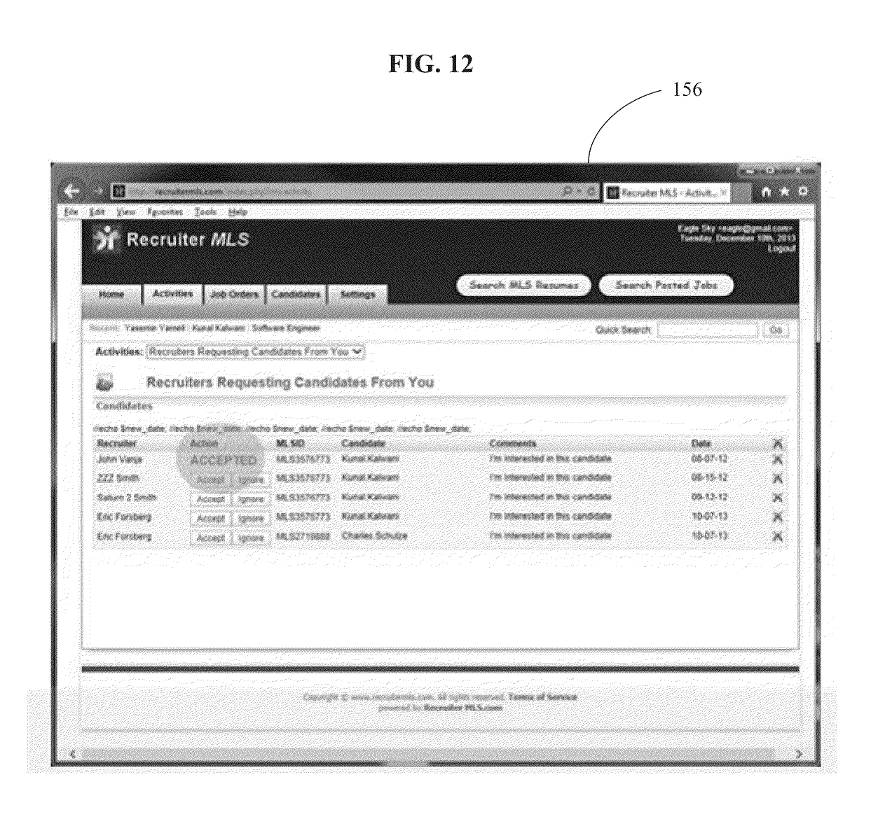

Referring now to FIGS. 9-12, a graphical user interface (“GUI”) of the system and method is shown. For example, FIG. 9 is an exemplary screen shot 150 of the GUI when the user is the JOR and is requesting candidates from a COR. The JOR can select particular CORs to forward a candidate request and the responses received from the particular CORs are displayed. As explained above, the COR reviews the request and can decide to approve the request and submit at least one potential candidate, or the COR can decline and not submit any candidates that the COR represents.

Likewise, when the user is the position of COR and the JOR is a third party, the screen shot 152 is displayed and allows the COR to select “Accept” or “Ignore” the candidate request submitted by the JOR using the GUI. For example, in screen shot 154, the user can select the “Ignore” button of the GUI and in screen shot 156 the user has selected the “Accepted” button of the GUI.

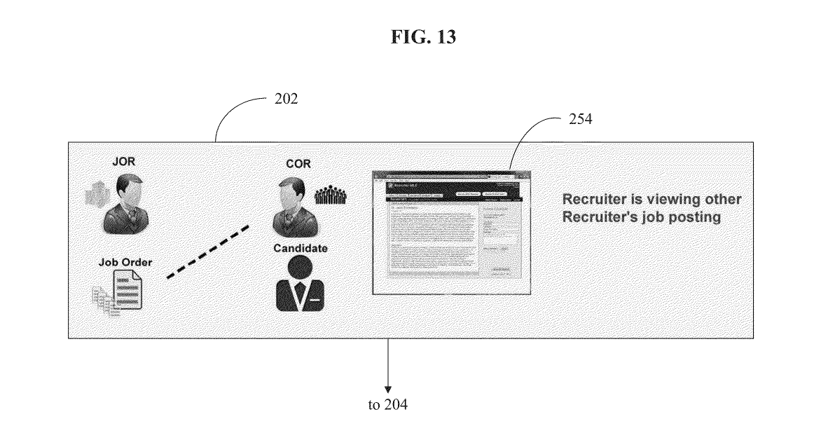

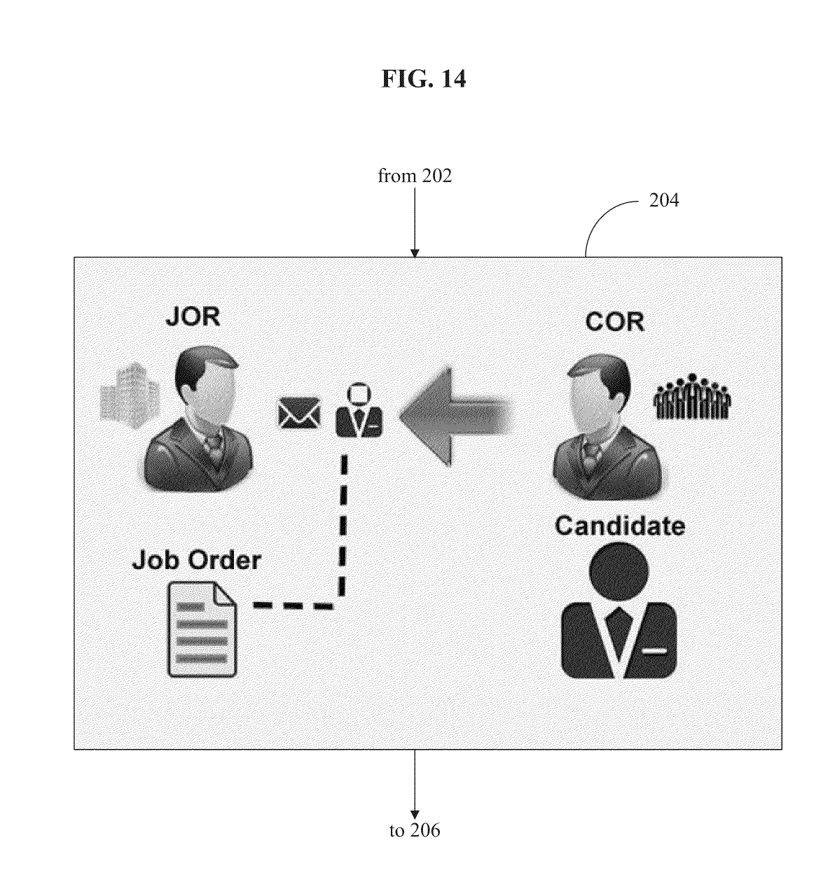

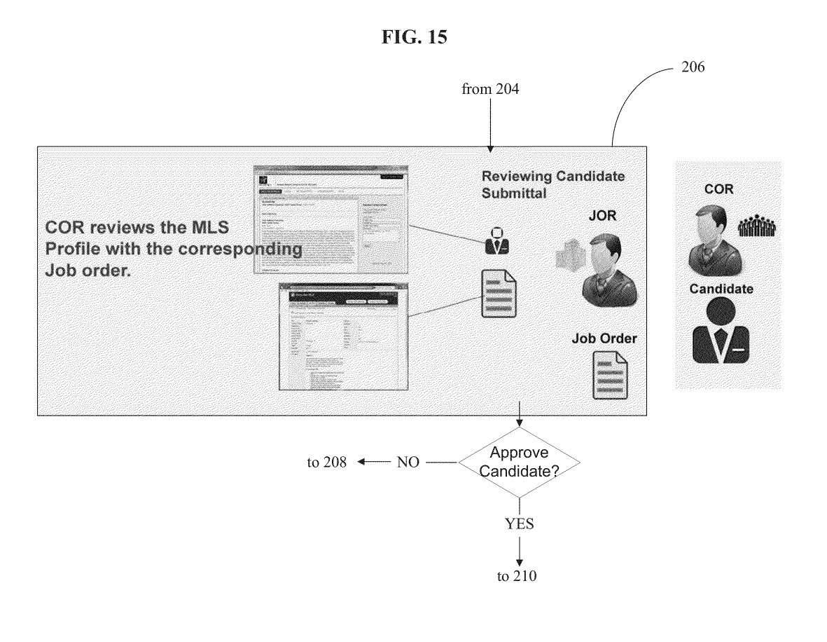

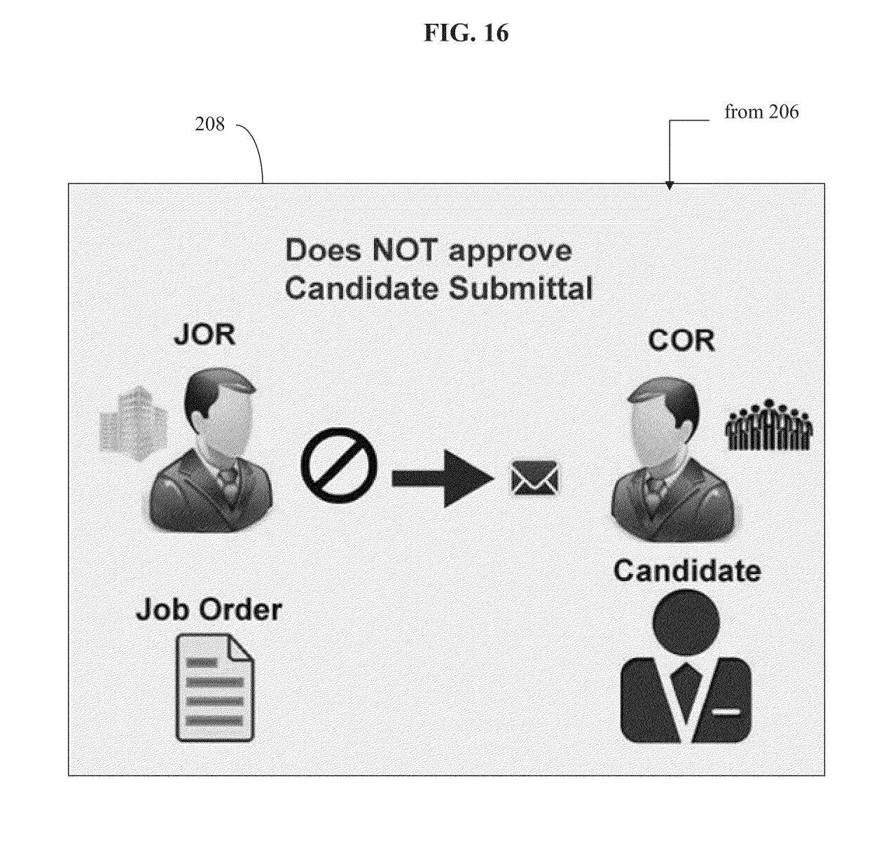

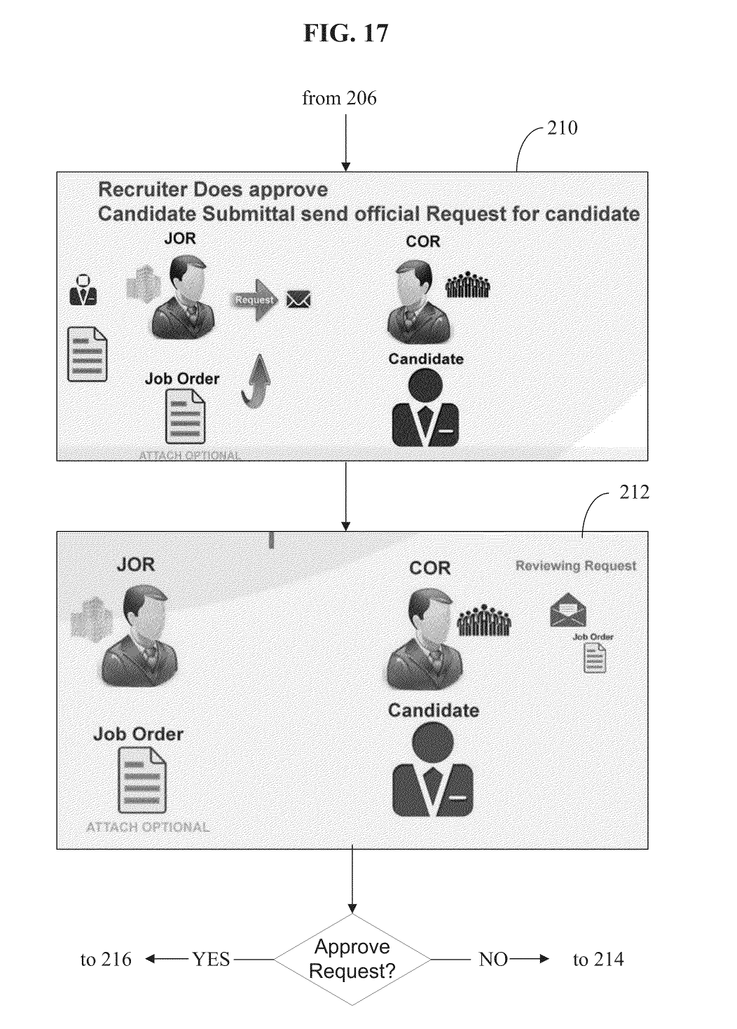

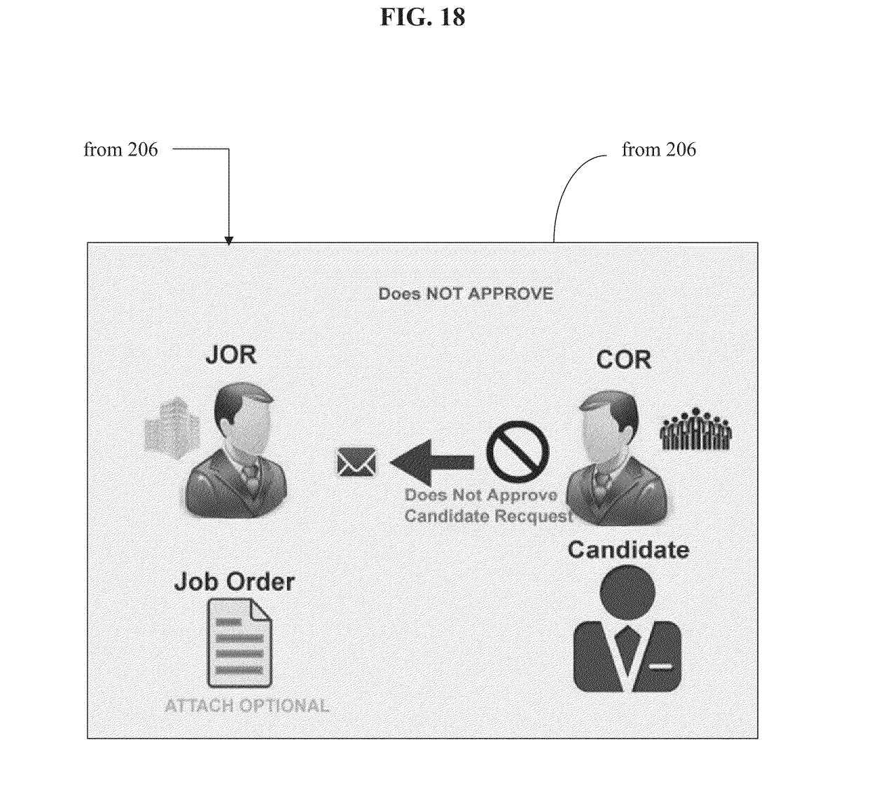

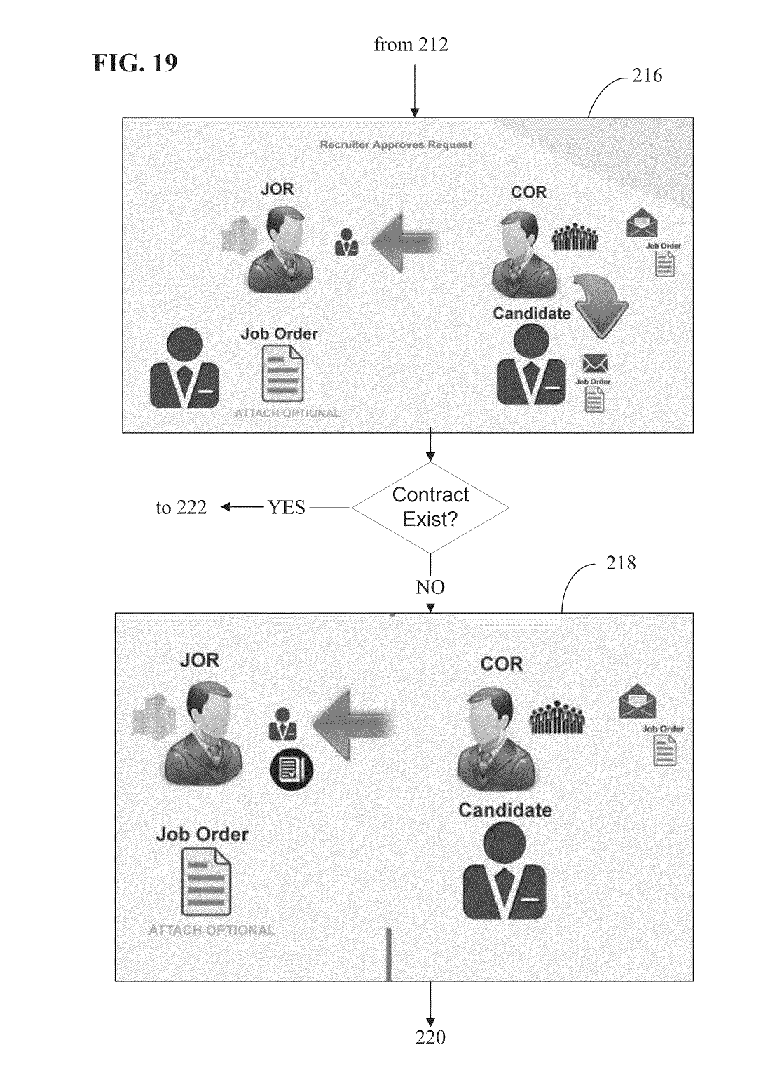

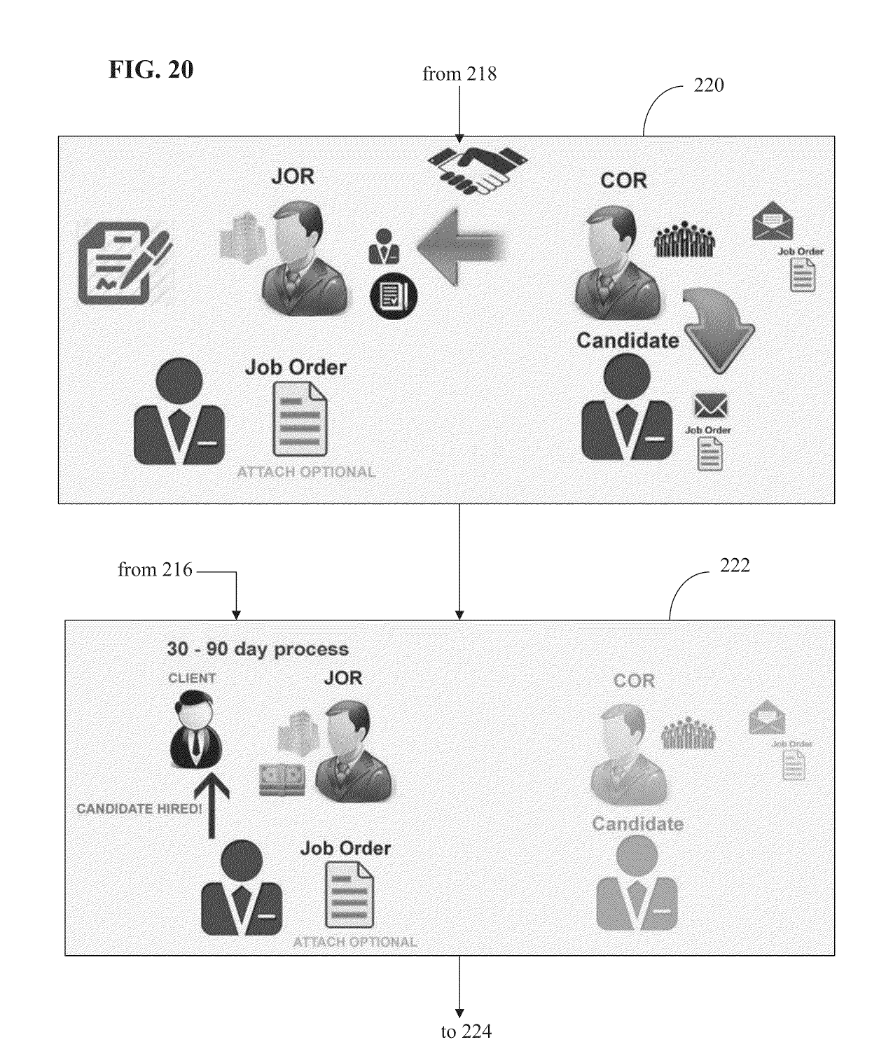

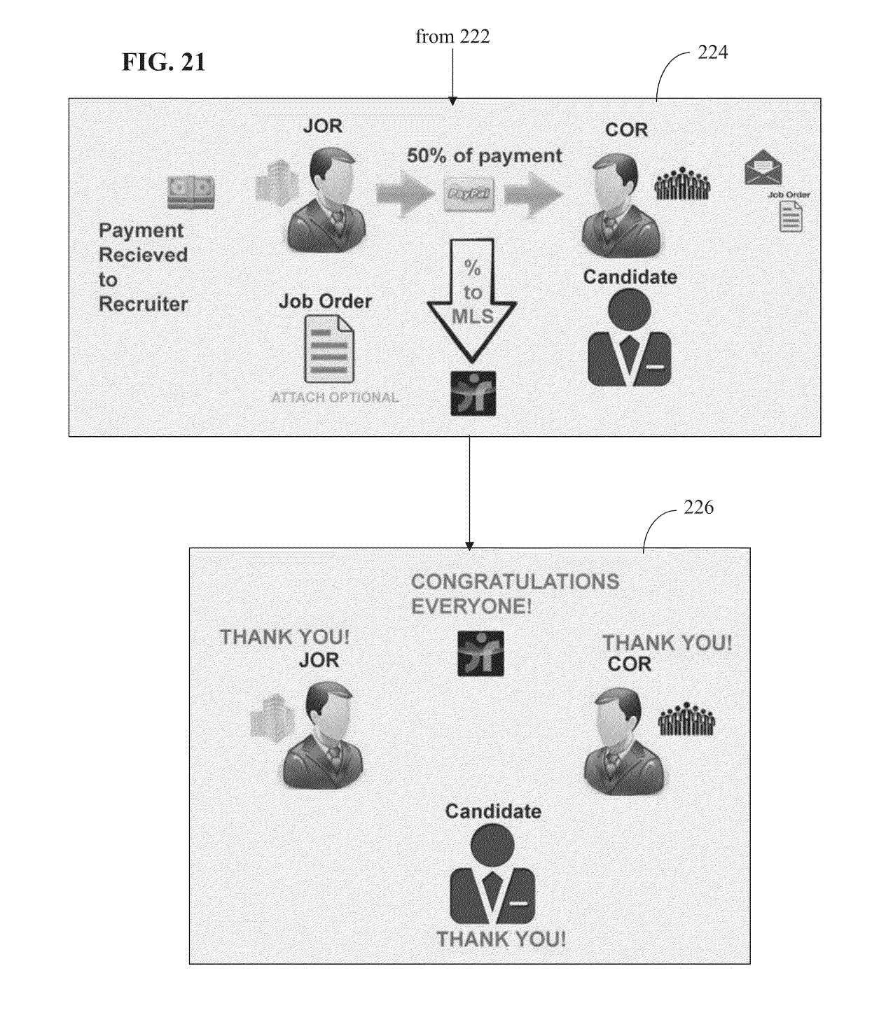

Referring now to FIGS. 13-21, the system and method for unifying an employment network is also configured, at 202, for a COR to review the job orders of the JOR. A screen shot 254 of the COR viewing the qualifications and requirements of the job orders that are displayed using the GUI is shown in FIG. 13. Once the COR identifies a job order for which the COR represents a matching candidate, the COR submits the candidate profile to the JOR using the GUI, at 204. Moving to 206, the COR reviews the candidate profile to determine whether to approve the candidate profile. If the candidate is not approved, at 208, by the JOR, then the GUI sends a response to the COR that the candidate was not accepted. If the JOR does approve the candidate submittal, then the GUI sends a response that the candidate was approved and sends an official request for the candidate, as 210. The COR receives the response, at 212, and decides whether to approve the candidate for the job request. If the COR does not approve the candidate request, then the GUI, at 206, sends a response to the JOR that the candidate is not available for the job request. When the COR does approve the candidate request, then the JOR will determine if a contract may exist between the selected candidate(s) and the JOR. If no contract exists, then the JOR and the selected candidate will execute a contract, at 218, and the JOR will present the selected candidate to the client for review, at 220. The selected candidate will be reviewed with the client, at 222, and hired. Moving to 224, once the selected candidate is hired, the JOR and COR will share the commission earned for placement of the selected candidate and concludes the process at 226.

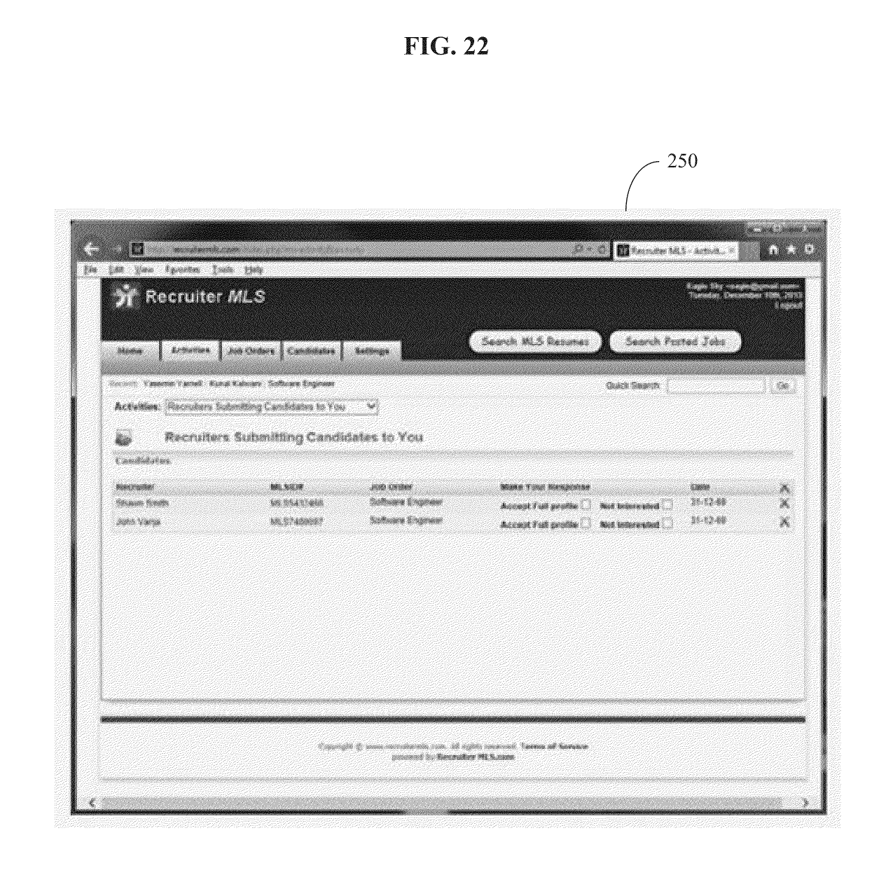

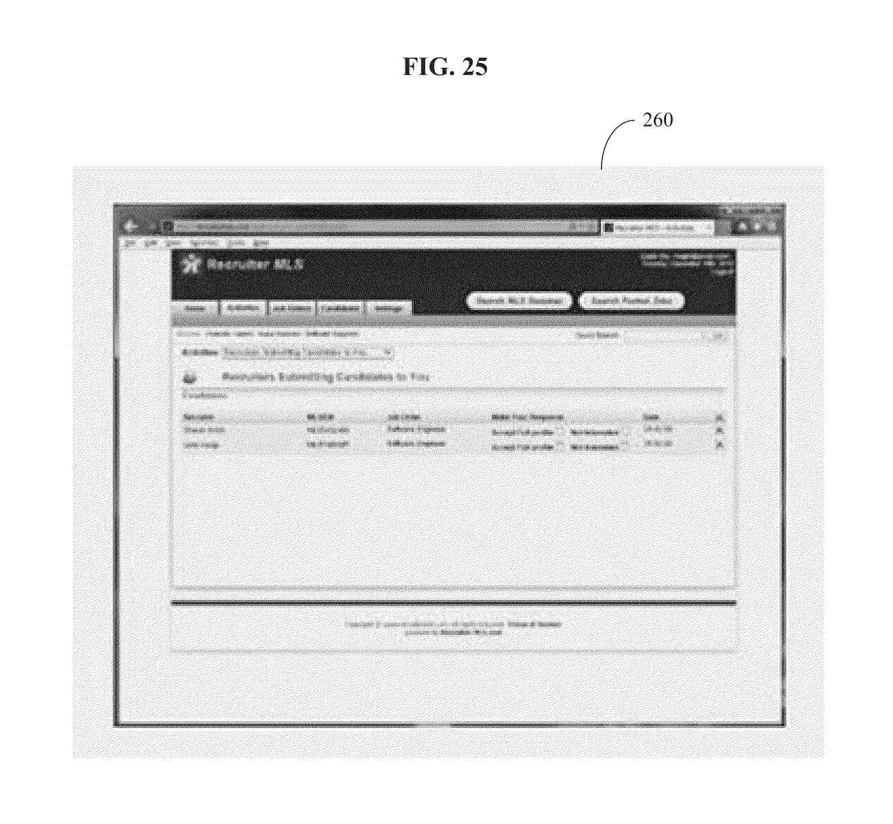

Referring now to FIGS. 22-26, screen shots from the GUI are shown. The screen FIG. 22 is a screen shot 250 of the GUI when the user is the JOR and is requesting candidates from a COR. The JOR can select particular CORs to forward a candidate request and the responses received from the particular CORs are displayed. As explained above, the COR reviews the request and can decide to approve the request and submit at least one potential candidate, or the COR can decline and not submit any candidates that the COR represents.

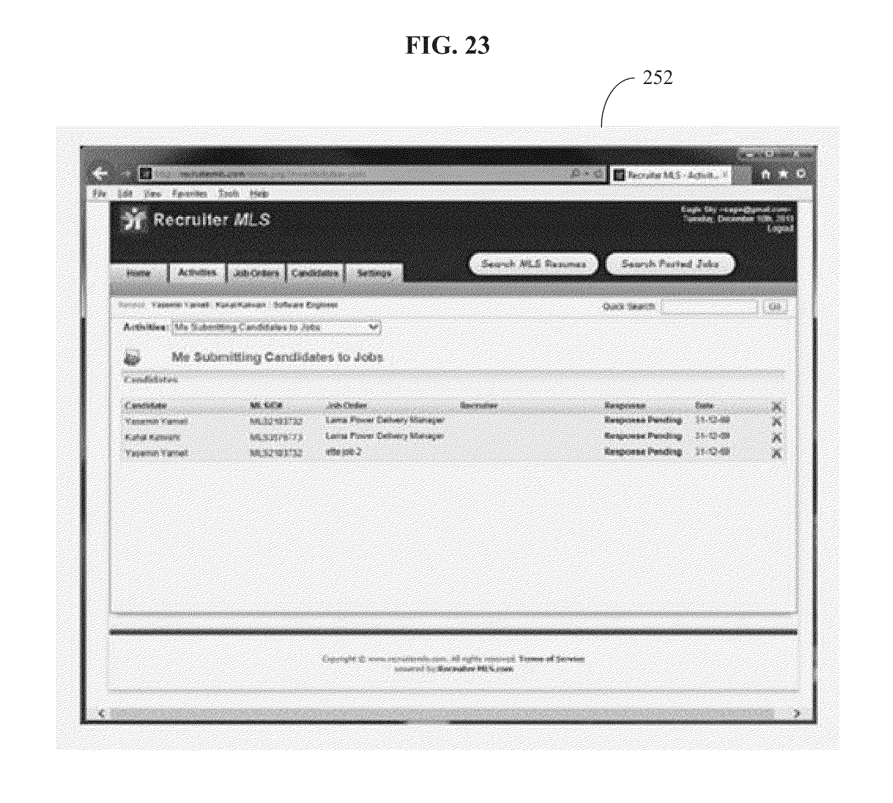

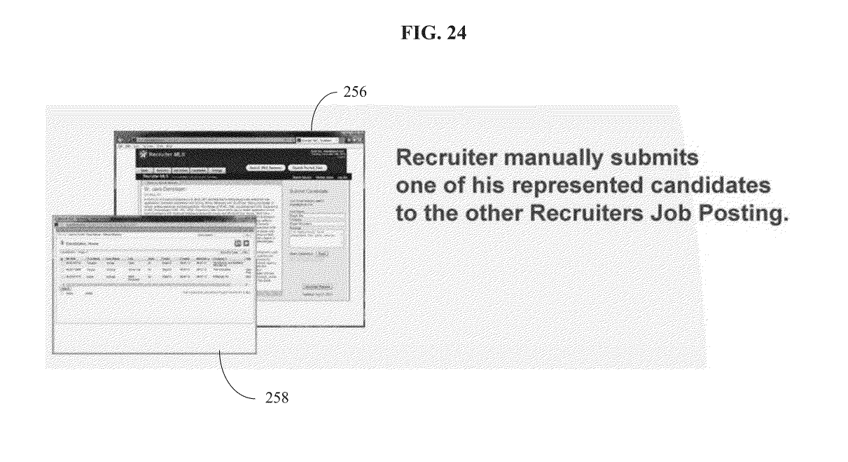

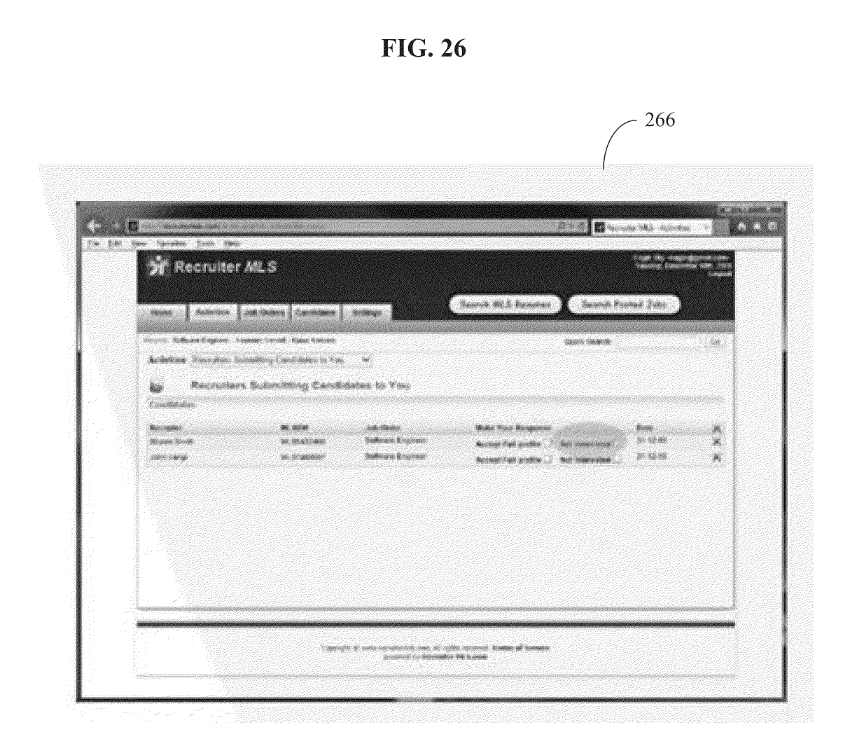

Likewise, when the user is the position of COR and the JOR is a third party, the screen shot 252 is displayed and allows the COR to submit a candidate to the JOR. The JOR has the option to select “Accept Full Profile” or select “Not Interested” using the GUI. The screen shot 252 shown in FIG. 23, shows that the COR is waiting for a response from the JOR for the particular candidates that were submitted for consideration. The screen shot 256 and 258 in FIG. 24 shows the user, as the COR, submitting one of his represented candidates to the JOR. The COR submits the candidate, as in screen shot 260, and the JOR reviews and can accept or select “Not Interested” as shown in screen shot 266 of FIG. 26.

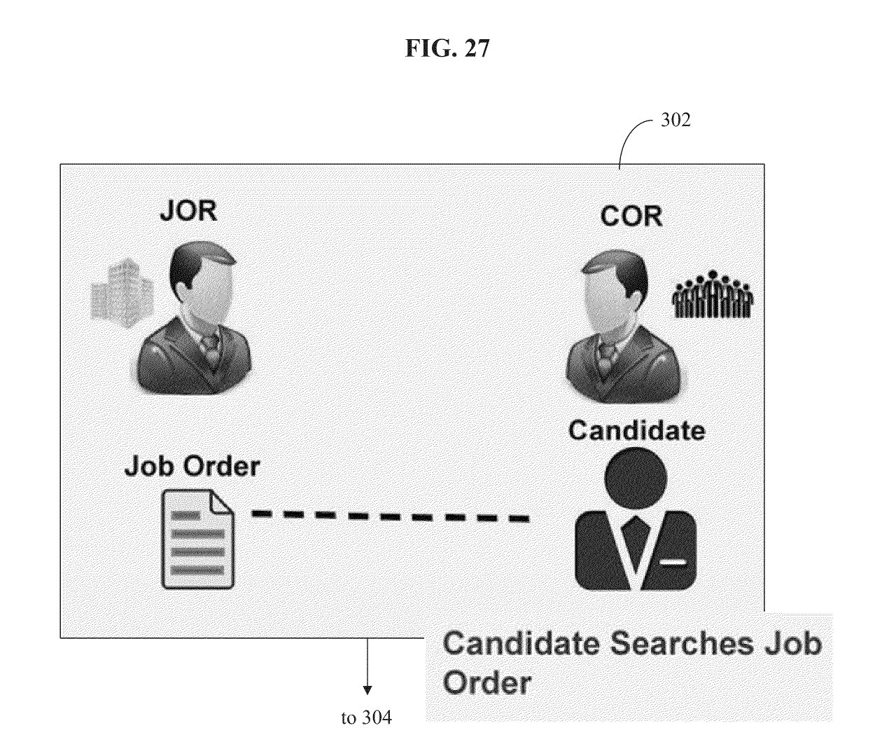

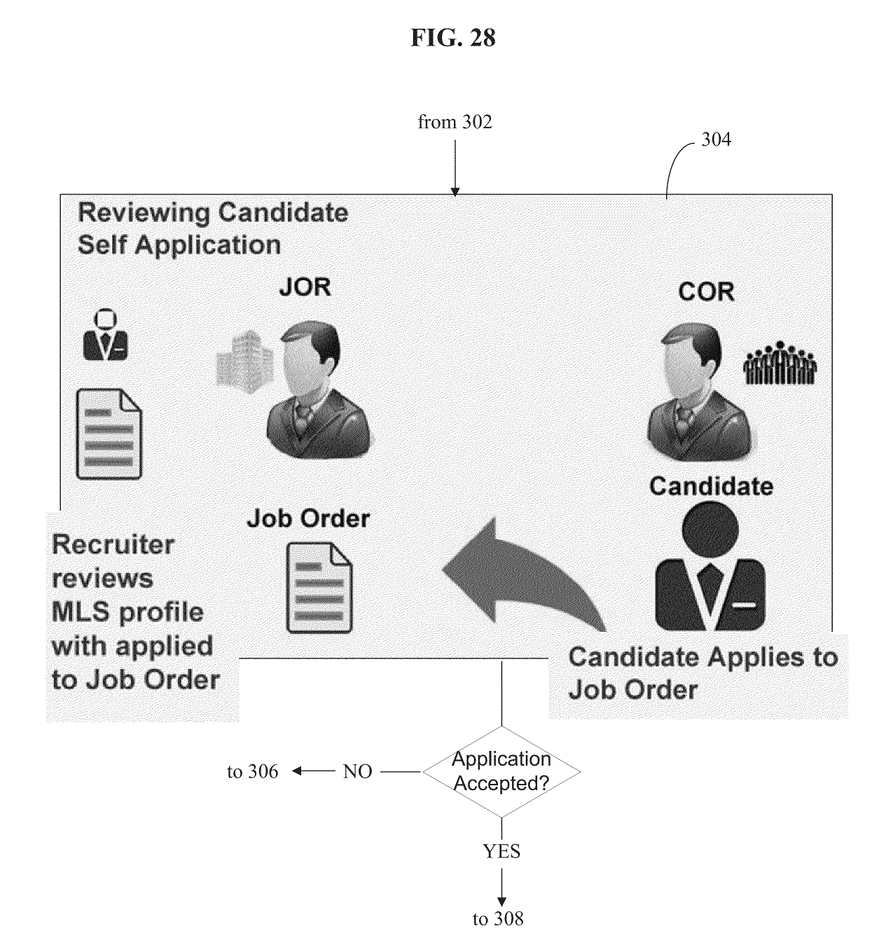

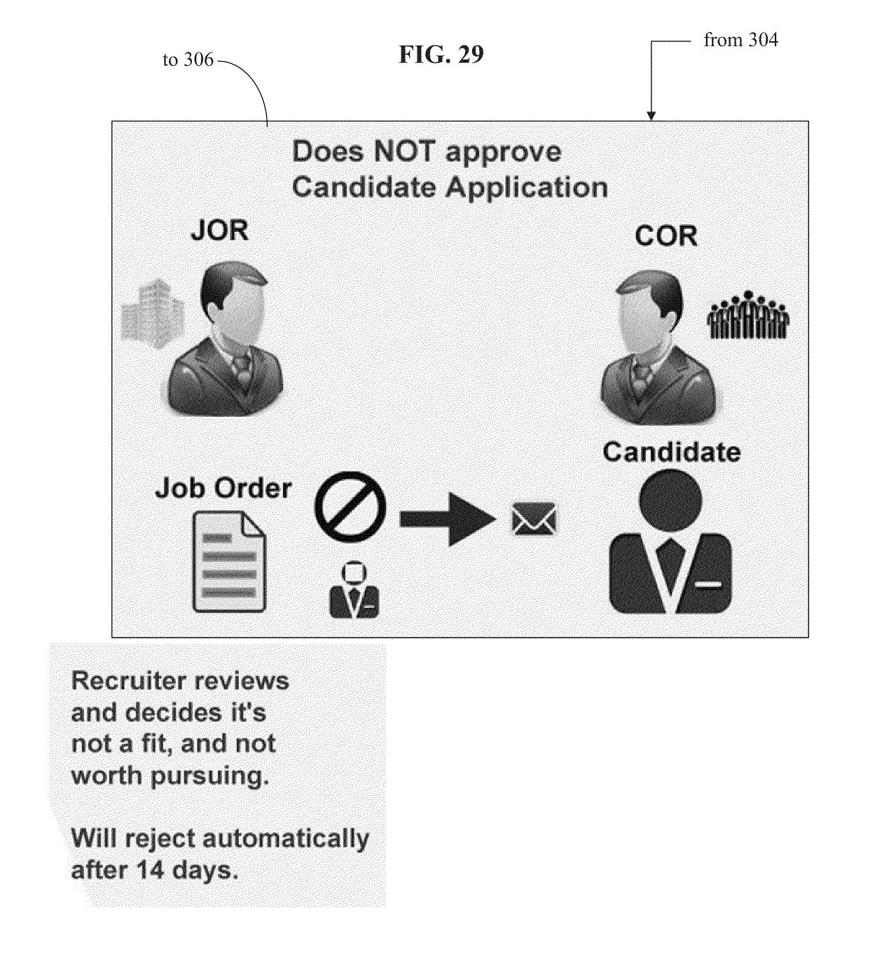

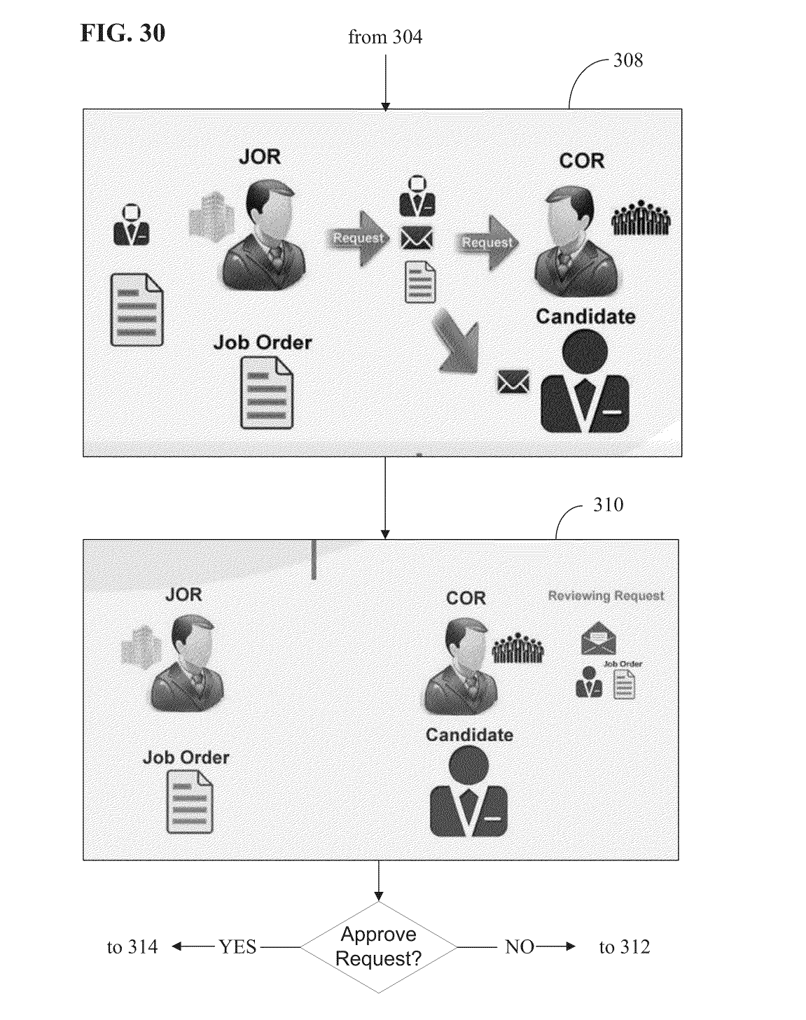

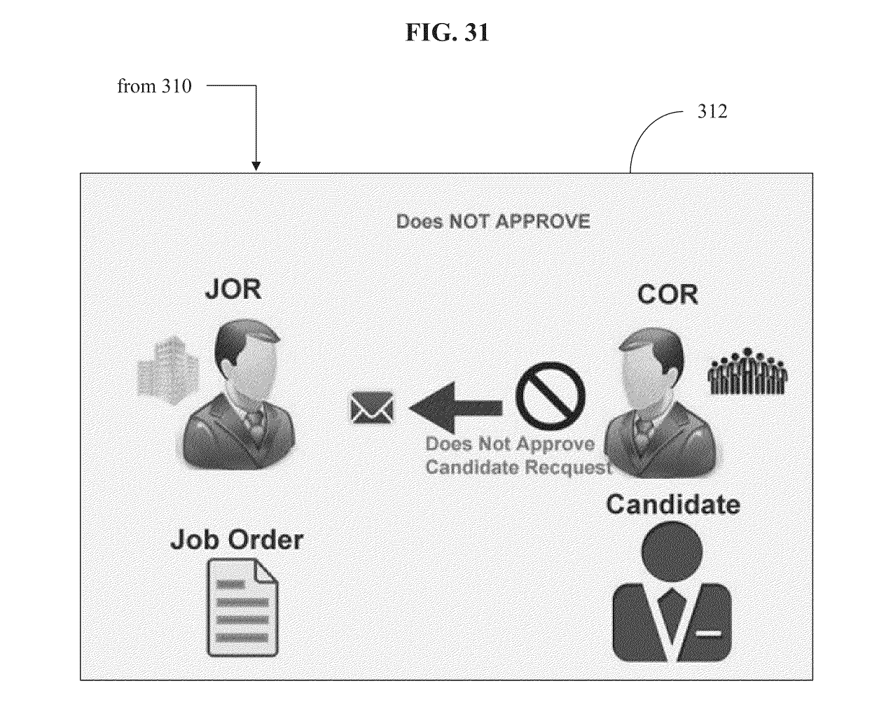

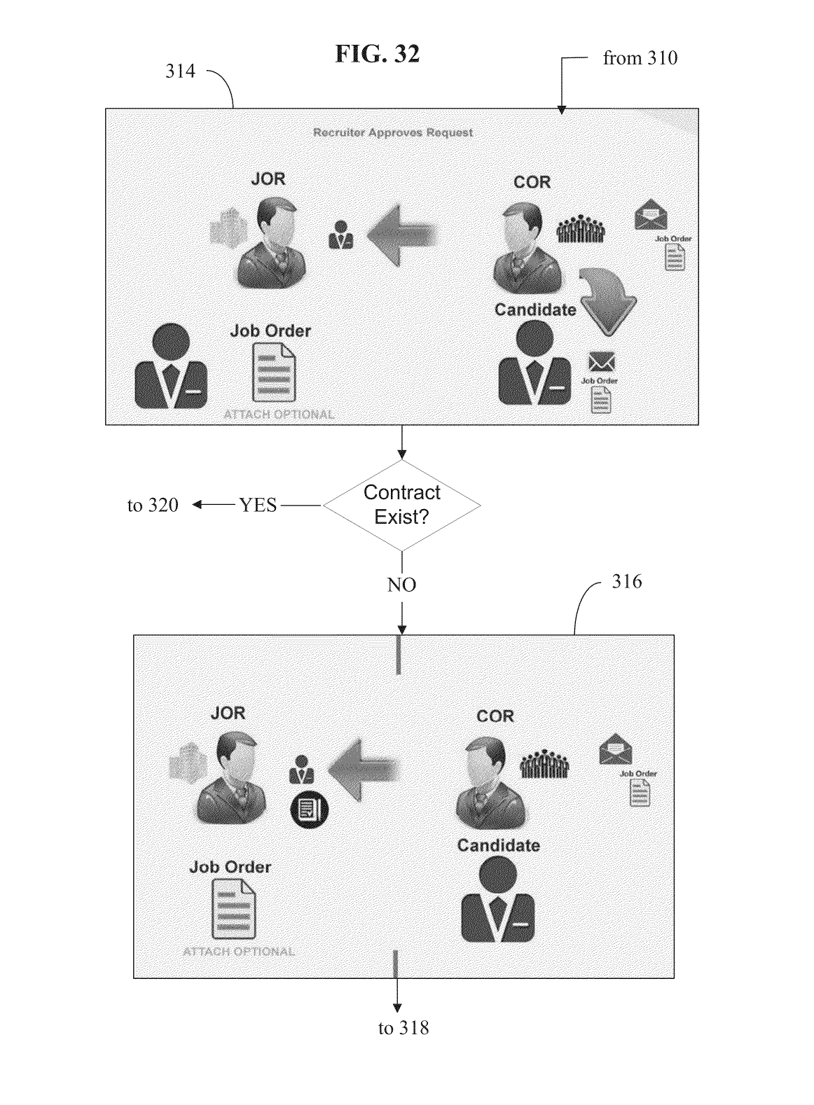

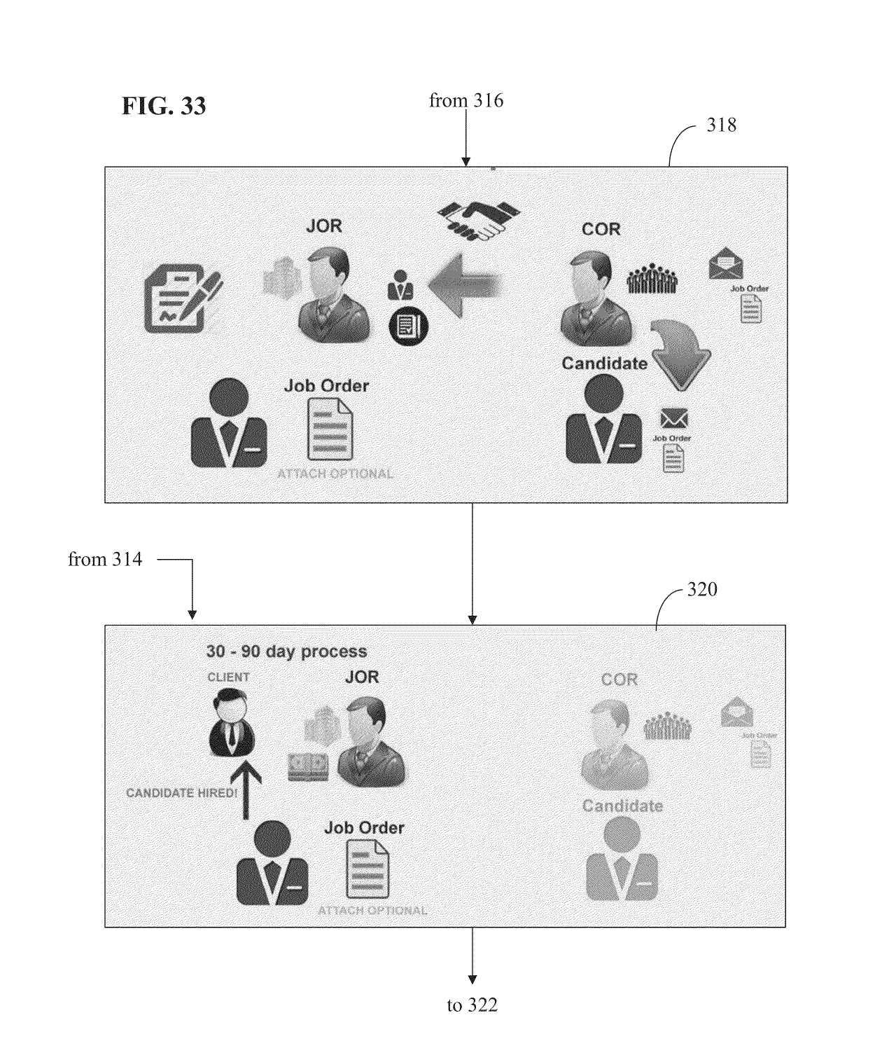

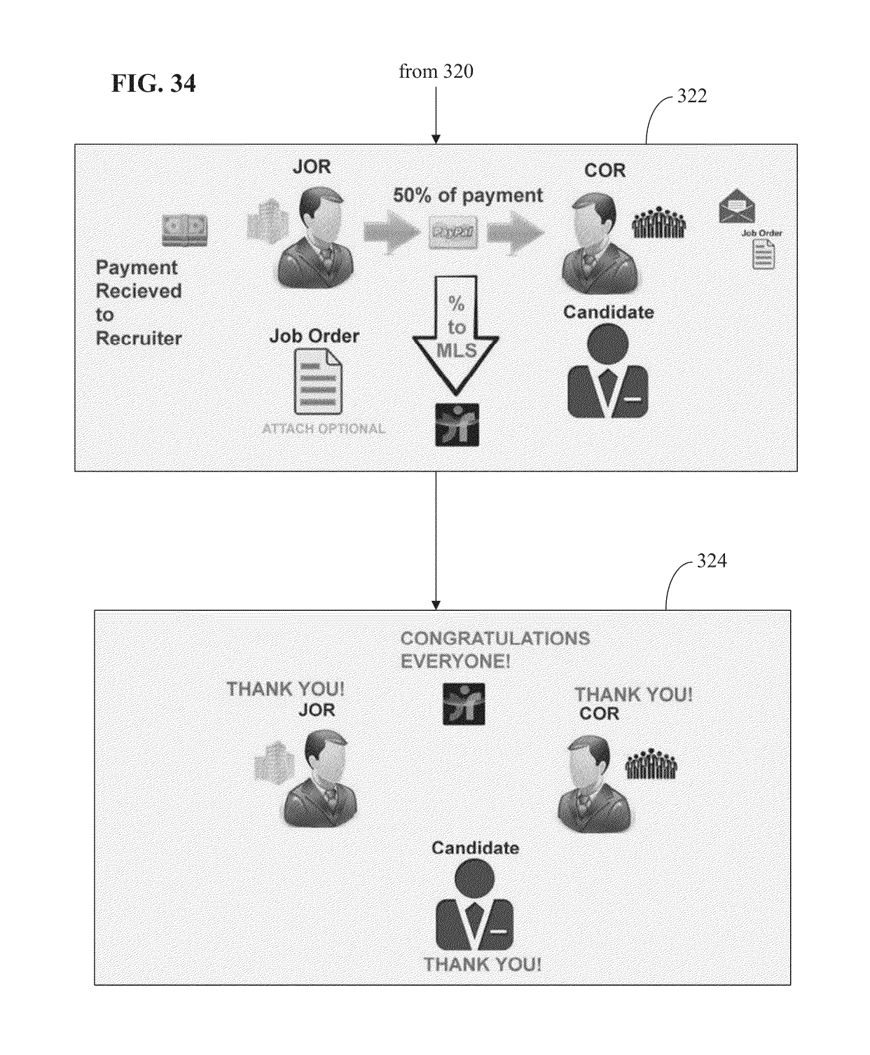

Referring now to FIGS. 27-34, in another aspect of the system and method candidates of the COR can search job orders of the JOR, at 302. The JOR reviews the candidate, at 304, to determine whether to accept the application. The JOR can decline the application from the candidate, at 306, and decide that the candidate is not worth pursuing for the job offer. If the JOR accepts the application, then at 308, the JOR submits a request to the respective COR. Moving to 310, the COR then reviews the request from the JOR and determines whether to approve the request. If the COR does not approve the candidate request, at 312, the COR sends a response to the JOR that the candidate is not available. At 314, if the COR approves the candidate request from the JOR, then the COR sends the appropriate response and the JOR determines whether a contract exists already between the candidate and the JOR. If no contract exists, then the candidate and the JOR enter into a contract for representation, at 318. The selected candidate will be reviewed with the client, at 322, and hired. Moving to 322, once the selected candidate is hired, the JOR and COR will share the commission earned for placement of the selected candidate and concludes the process at 324.

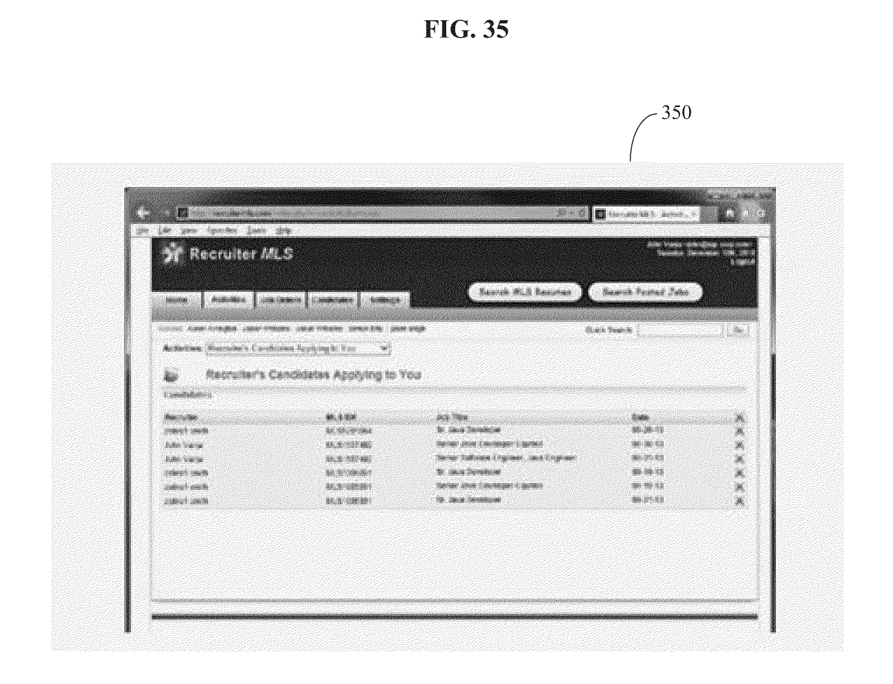

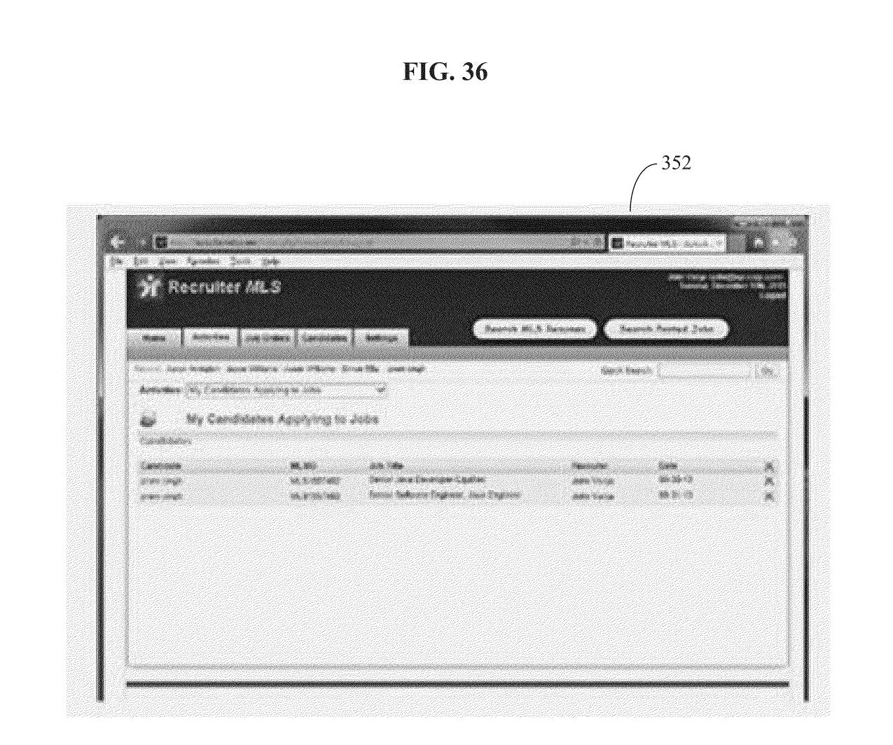

Referring now to FIGS. 35-40, screen shots from the GUI are shown. FIG. 35 is a screen shot 350 of the GUI for the JOR when the candidates of the COR are applying directly to the JOR. FIG. 36 is a screen shot 352 of the GUI for the COR showing the candidates that are applying directly to the JOR.

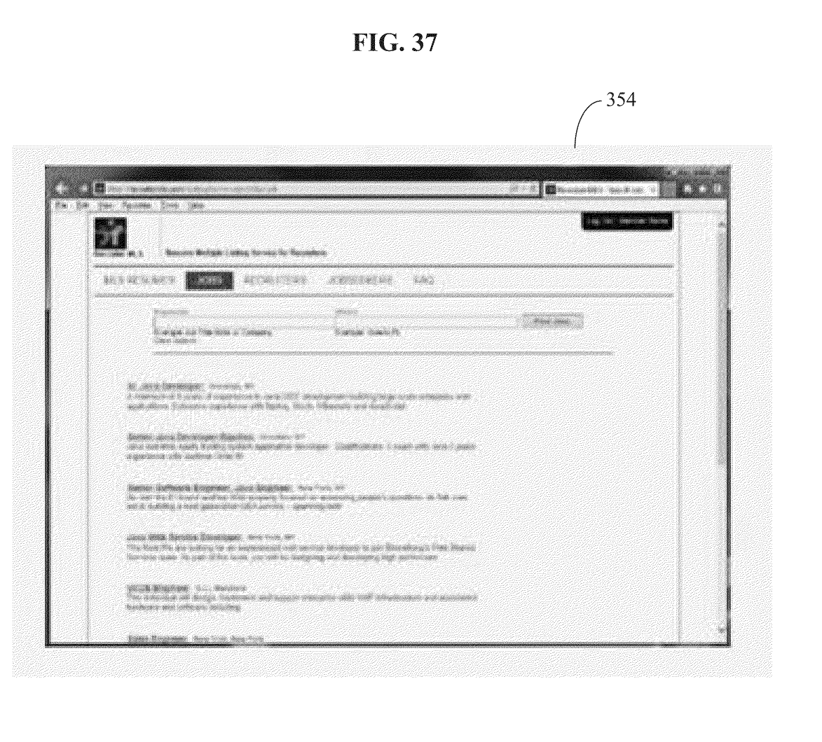

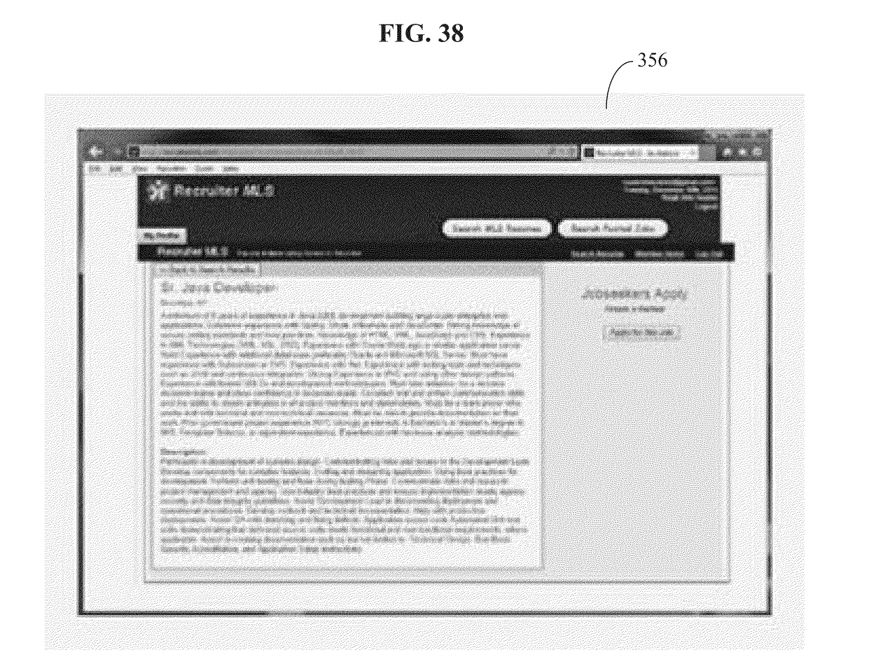

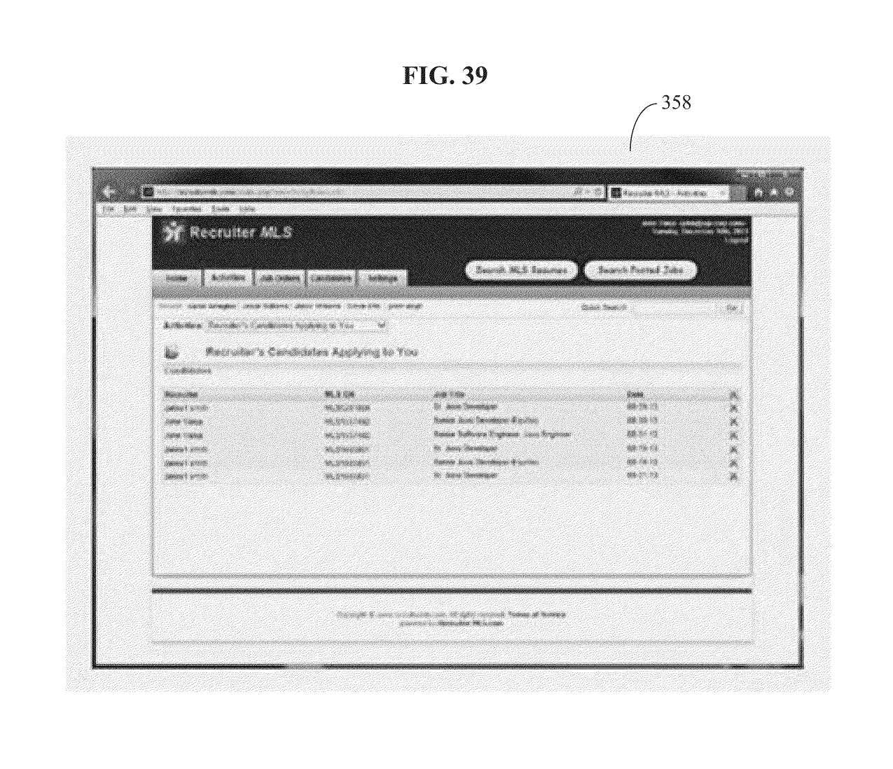

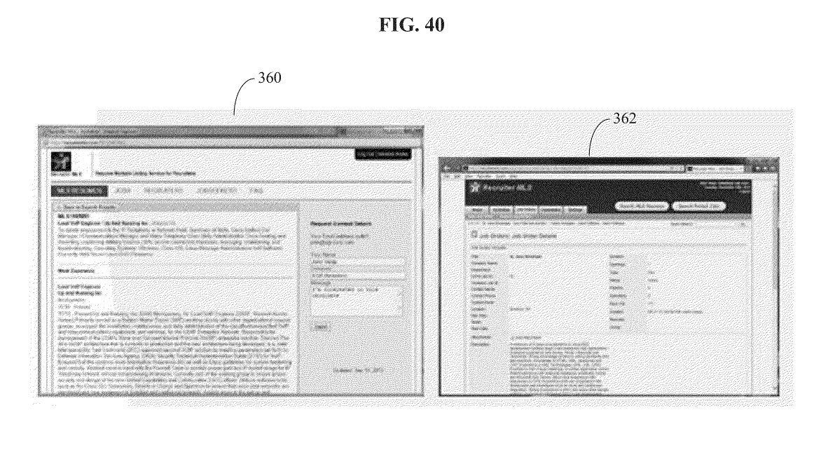

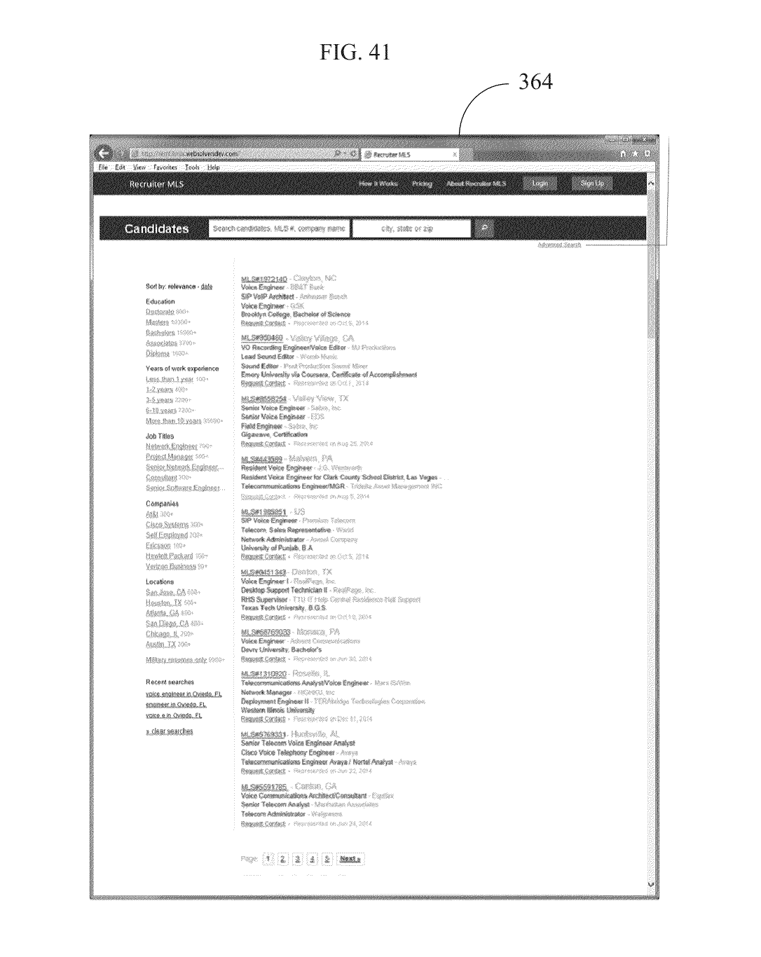

FIG. 37 is a screen shot 354 of the job orders that are available and viewable using the GUI. Screen shot 356 of FIG. 38, is a detailed job description that includes the requirements and qualifications, for example, of the job order. The JOR then reviews the candidates that have applied directly in response to the job orders. Screen shot 358 of the GUI in FIG. 39 shows the names of the candidates and the respective job order for which the candidate is applying. The JOR can then review the profile of the candidate using the GUI, where screen shots 360, 362 of FIG. 40 show the information of the candidate. FIG. 41 is a screen shot of the GUI 364 showing the candidates that are viewable by other recruiters.

A computer system can include a set of instructions that can be executed to cause the computer system to perform any one or more of the methods or computer based functions disclosed herein. The computer system, or any portion thereof, may operate as a standalone device or may be connected, e.g., using a network, to other computer systems or peripheral devices. In a networked deployment, the computer system may operate in the capacity of a server, such as a video server or application server, or a media device. The computer system can also be implemented as or incorporated into various devices, such as a personal computer (PC), a personal digital assistant (PDA), a mobile device, a palmtop computer, a laptop computer, a desktop computer, a communications device, a wireless telephone, a web appliance, a network router, switch or bridge, or any other machine capable of executing a set of instructions (sequential or otherwise) that specify actions to be taken by that machine. In a particular embodiment, the computer system can be implemented using electronic devices that provide voice, video or data communication. Further, while a single computer system is illustrated, the term “system” shall also be taken to include any collection of systems or sub-systems that individually or jointly execute a set, or multiple sets, of instructions to perform one or more computer functions.

The computer system may include a processor, e.g., a central processing unit (CPU), a graphics-processing unit (GPU), or both. Moreover, the computer system can include a main memory and a static memory that can communicate with each other via a bus. As shown, the computer system may further include a video display unit, such as a liquid crystal display (LCD), a flat panel display, a solid-state display, or a cathode ray tube (CRT). Additionally, the computer system may include an input device, such as a keyboard, and a cursor control device, such as a mouse. The computer system can also include a disk drive unit, a signal generation device, such as a speaker or remote control, and a network interface device.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

Now that the invention has been described,

What is claimed is:

1. A system for unifying an employment network of recruiters, the system comprising:
a database configured to store and access information associated with a plurality of candidate profiles, a plurality of job requests, a plurality of job owner recruiters, and a plurality of candidate owner recruiters; and
graphical user interface (“GUI”) in communication with the database and the employment network of recruiters, the GUI configured to:
receive the plurality of job requests from the plurality of job owner recruiter for at least one candidate profile in order to fill at least one of the plurality of job requests;
receive the at least one candidate profile associated with a respective candidate owner recruiter in response to fill the at least one of the plurality of job requests;
receive a request from a respective job owner recruiter to notify the respective candidate owner recruiter when the respective job owner recruiter accepts the at least one candidate profile to fill the at least one job request; and
match the at least one job request to a candidate associated with the at least one candidate profile in order to display a full candidate profile to the job owner recruiter.

2. The system of claim 1, the GUI further configured to receive instructions from the candidate to submit its own candidate profile directly to the respective job owner recruiter in order for the respective job owner recruiter to elect to contact the candidate owner recruiter associated with the candidate upon reviewing the candidate profile.

3. The system of claim 2, wherein the GUI includes a set of navigational links on a web page.

4. The system of claim 3, wherein the candidate owner recruiter is party to a contract providing for receipt of a commission as a result of a transaction involving the candidate filling the job request.

5. The system of claim 4, further comprising computer-facilitating payment of the commission to the candidate owner recruiter once the transaction is completed.

6. The system of claim 5, further comprising after the transaction is completed, payment of a portion of the commission to the job owner recruiter.

7. The system of claim 6, further comprising after the transaction is completed, computer-facilitating payment of a commission to an owner of the system.

8. A method for unifying an employment network of recruiters, the method comprising:
storing in a database information associated with a plurality of candidate profiles, a plurality of job requests, a plurality of job owner recruiters, and a plurality of candidate owner recruiters;
receiving at a graphical user interface (“GUI”) coupled to the database and the employment network of recruiters the plurality of job requests from the plurality of job owner recruiter for at least one candidate profile in order to fill at least one of the plurality of job requests;
receiving at the GUI the at least one candidate profile associated with a respective candidate owner recruiter in response to fill the at least one of the plurality of job requests;
receiving at the GUI a request from a respective job owner recruiter to notify the respective candidate owner recruiter when the respective job owner recruiter accepts the at least one candidate profile to fill the at least one job request; and
matching the at least one job request to a candidate associated with the at least one candidate profile.

9. The method of claim 8, further comprising receiving instructions from the candidate to submit its own candidate profile directly to the respective job owner recruiter in order for the respective job owner recruiter to elect to contact the candidate owner recruiter associated with the candidate upon reviewing the candidate profile.

10. The method of claim 9, further comprising paying automatically the candidate owner recruiter a commission as a result of a transaction involving the candidate filling the at least one job request.

11. A non-transitory computer readable medium for performing steps of unifying an employment network of recruiters, the steps comprising:
storing in a database information associated with a plurality of candidate profiles, a plurality of job requests, a plurality of job owner recruiters, and a plurality of candidate owner recruiters;
receiving at a graphical user interface (“GUI”) coupled to the database and the employment network of recruiters the plurality of job requests from the plurality of job owner recruiter for at least one candidate profile in order to fill at least one of the plurality of job requests;
receiving at the GUI the at least one candidate profile associated with a respective candidate owner recruiter in response to fill the at least one of the plurality of job requests;
receiving at the GUI a request from a respective job owner recruiter to notify the respective candidate owner recruiter when the respective job owner recruiter accepts the at least one candidate profile to fill the at least one job request; and
matching the at least one job request to a candidate associated with the at least one candidate profile.
